(19) United States
(12) Patent Application Publication
(10) Pub. No.: US 2026/0358216 A1
(43) Pub. Date: Nov. 12, 2026

(54) MULTI-OSCILLATOR VISCOELASTIC SENSING

(71) Applicant: HYDRAMOTION LTD, North Yorkshire (GB)

(72) Inventor: John GALLAGHER, North Yorkshire (GB)

(21) Appl. No.: 19/488,244

(22) PCT Filed: May 28, 2024
(86) PCT No.: PCT/GB2024/051368

§ 371 Date: Nov. 26, 2025

(30) Foreign Application Priority Data
May 26, 2023 (GB) 2307930.4

(51) Int. Cl. G01N 9/00; G01N 11/16

(52) U.S. Cl. CPC G01N 9/002; G01N 11/16

(57) ABSTRACT

Aspects include the use of a vibratory transducer having multiple oscillators including a first oscillator (220) and a second oscillator (210), wherein the first and second oscillators are coupled such that excitation (vibration) of the first oscillator excites (causes to vibrate) the second oscillator in a viscoelastic fluid (240). Because the frequency response of the dual-oscillator combination is affected by fluid properties, measuring one or more of: i) resonant frequency, ii) vibration amplitude, iii) loss factor (or Q factor), of the combination of the vibration of the first and second oscillators in the viscoelastic fluid, can be used to determine or one or more of the following properties of the viscoelastic fluid: i) density, ii) viscosity (such as the dynamic viscosity, μ′), iii) elasticity (such as the storage modulus, G′).

### TECHNICAL FIELD

This disclosure relates to the damping of vibrations within fluids, including the use of damping to obtain measurements of physical and rheological properties of materials such as measurements of viscosity.

### BACKGROUND

Physical and rheological properties of a fluid can be measured by applying an oscillatory stimulus to the fluid and observing a fluid mechanical response. From an observed fluid mechanical response (for example, a degree of damping and/or stiffness, and/or a resonant frequency), a measurement of a property of a fluid can be obtained, such as viscosity, density, storage modulus, loss modulus, and loss tangent.

By way of example, a degree of damping may be determined from an amplitude of vibration or a change in amplitude, a resonant frequency or a change in resonant frequency, a rate of decay of vibration, or a quality (Q) factor, or a loss factor, which is the reciprocal of a quality factor.

Resonant viscometers measure viscosity by determining the damping effect that viscous fluids have on a mechanical oscillator immersed in the fluid. The presence of viscosity increases shear stress at the oscillator surface. The shear stress creates a damping force, which dissipates energy from the oscillator. For a mechanical oscillator operating at resonance, this reduces the Q factor at resonance. The Q factor is therefore an inverse indicator of the viscosity. The loss factor is the inverse of the Q factor, and therefore an increase in viscosity causes an increase in the loss factor. Historically, resonant viscometers have been shown to work well (i.e. that their loss factor effectively varies with fluid viscosity) with purely viscous fluids and fluids that are mildly viscoelastic (non-Newtonian fluids) where the tan Δ (i.e. the loss tangent) is greater than 1.

The loss tangent is given by the following expression: tan Δ=ωμ′/G′, where ω is the angular frequency of oscillation, μ′ is the dynamic viscosity of the fluid, and G′ is the storage modulus of the fluid.

Newtonian fluids are purely viscous, i.e. without any elastic behaviour. There is no storage modulus. The loss tangent, tan 4, is infinite. Examples of such fluids are water, aqueous solutions, sugar syrups, alcohol, most pure oils, most hydrocarbons, and gases.

Non-Newtonian fluids may be viscoelastic and so have tan Δ<∞. Examples of viscoelastic fluids include blood, suspensions, emulsions, and most synthetic materials. Strongly viscoelastic fluids may have tan Δ<1. Examples of strongly viscoelastic fluids include liquid polymers, polymer melts, rubber solutions, synthetic oils, detergents and foodstuffs.

### SUMMARY

Aspects according to this disclosure include the use of a vibratory transducer having multiple oscillators including a first oscillator and a second oscillator, wherein the first and second oscillators are coupled such that excitation (vibration) of the first oscillator excites (causes to vibrate) the second oscillator in a viscoelastic fluid.

Because the frequency response of the dual-oscillator combination is affected by fluid properties, measuring one or more of (e.g. all three of):
i) resonant frequency,
ii) vibration amplitude,
iii) loss factor (or Q factor)
   of the combination of the vibration of the first and second oscillators in the viscoelastic fluid, can be used to determine or one or more of (e.g. all three of) the following properties of the viscoelastic fluid:
i) density,
ii) viscosity (such as the dynamic viscosity, μ′),
iii) elasticity (such as the storage modulus, G′).

The first and second oscillators can be configured for lateral vibration, longitudinal vibration, torsional vibration, or a combination of these types of vibration. For example, the first oscillator may be configured for torsional vibration and the second oscillator may be configured for lateral vibration.

In some examples, both the first oscillator and second oscillator are configured to vibrate in contact with the fluid. Alternatively, in some other examples only one of the oscillators is in contact with the fluid.

One or both of the first and second oscillators may have dimensions relative to the fluid properties such that geometric damping is achieved. For example, the second oscillator may comprise an elongate member characterised by a width, a half width that is equal to half of the width, and a length that is greater than the width, wherein the half width is less than a propagation depth of a shear wave in the fluid at the vibration frequency. The propagation depth is a distance over which an amplitude of a shear wave propagating in the fluid at the vibration frequency is reduced by a factor of 1/e, wherein e is the base of natural logarithms.

For example, the propagation depth of a shear wave propagating in the fluid at the vibration frequency may be given by the expression:

$$\frac{1}{sin \frac{Δ}{2}} \sqrt{\frac{μ}{ρ ω sin Δ}} ,$$

wherein μ is a viscosity of the fluid, ρ is a density of the fluid, ω is the angular frequency of vibration, and Δ varies between 0 and π/2 and is defined by the loss tangent, tan Δ, and wherein tan Δ is equal to the following expression, in which G′ is a storage modulus of the fluid:

$$\frac{μ ω}{{G}^{′}} .$$

During vibration, flow of fluid around such an elongate member may be laminar flow during vibration of the elongate member. Optionally, the elongate member may have a first end and a second end, wherein one or both of the first and second ends is spaced from the longitudinal axis of a vibrational shaft from which the elongate member's vibrations are driven (which may comprise or form part of the first oscillator) by an offset distance that is greater than the half width of the elongate member. Optionally or additionally, during vibration of the one or more vibratory transducers in the fluid at a vibration frequency, a Reynolds number, Re, of fluid flow around the elongate member is less than 1000, preferably less than 100, more preferably less than 10, even more preferably less than 1, wherein the Reynolds number is given by:

$$Re = \frac{2 R v ρ}{{μ}^{′}} ,$$

wherein μ′ is a viscosity of the fluid, ρ is a density of the fluid, R is the half width of the elongate member, and ν is a maximum velocity of the elongate member relative to the fluid during vibration of the one or more vibratory transducers.

The excitation of the first oscillator may be at a frequency that is near (e.g. within 30%, 20%, 10%, 5%, 2%, or 1%) to a natural frequency of the second oscillator. The primary oscillator may be configured to have a natural frequency that is near to a natural frequency of the second oscillator (e.g. within 50%, 40%, 30%, 20%, 10%, 5%, 2%, or 1%). Preferably, one or both of the excitation frequency of the first oscillator and the natural frequency of the first oscillator is/are within 20% of the natural frequency of the second oscillator, more preferably within 10%, more preferably still within 5%, even more preferably still within 2%, even more preferably still within 1%.

Aspects according to this disclosure include the use of a vibratory transducer as described above, driving or exciting the first oscillator at two different frequencies, of which a first frequency is relatively closer to the natural frequency of the second oscillator than a second frequency. The first frequency may be within a threshold of the natural frequency of the second oscillator (e.g. within 50%, 40%, 30%, 20%, 10%, 5%, 2%, or 1%) and the second frequency outside of (e.g. less than) that threshold. Vibration at the second frequency might excite first oscillator to vibrate but not excite the second oscillator. Thus two different excitation regimes might be used for measurement.

In such techniques, measurements of amplitude, or loss factor (or Q factor), or frequency (such as resonant frequency) at the first and second frequencies allows differences between corresponding measurements or ratios of corresponding measurements or some other comparison between corresponding measurements to improve the fluid viscosity or elasticity measurements. This may be via rejection of common-mode noise for example.

Aspects according to this disclosure include the use of a vibratory transducer as described above, driving or exciting the first oscillator at multiple different frequencies, of which a first frequency is relatively close to the natural frequency of the second oscillator (e.g. within 50%, 40%, 30%, 20%, 10%, 5%, 2%, or 1%), and one or more other frequencies are further away from the natural frequency of the second oscillator.

Measurement of amplitude, Q factor (or loss factor) and frequencies reveal, from these multifrequency measurements, signatures for fluid measurement and identification.

For example, measurements may be made of an unknown fluid and compared with predetermined data comprising signatures of multiple fluids, and an estimate of the unknown fluid may be determined. For example, a signature in the predetermined data that is most similar to the measurements of the unknown fluid may be determined to estimate the unknown fluid.

Aspects according to this disclosure include the use of two coupled oscillators where the harmonic response of one oscillator under fluid loading influences the other. Aspects according to this disclosure also include a device comprising such coupled oscillators.

Aspects according to this disclosure include the use of a vibrational transducer (device) where measured amplitude, Q-factor (loss factor) and frequency varies monotonically with both μ′ and G′. Aspects according to this disclosure also include such a vibrational transducer or a device or system comprising such a vibrational transducer.

Aspects according to this disclosure include the use of a vibrational transducer (device) that includes a coupled oscillator where one oscillator is excited at a frequency near the resonance of the second oscillator and also at a frequency very different from the resonant frequency of the second oscillator. Ratios and differences of amplitude, loss factor and frequency provide improvements of fluid μ′ and G′ measurements. Aspects according to this disclosure also include such a vibrational transducer or a device or system comprising such a vibrational transducer.

Aspects according to this disclosure include the use of vibrational (vibratory) transducer (device) that includes a coupled oscillator where one oscillator is excited at a frequency near the resonance of the second oscillator and also at multiple frequencies very different from the resonant frequency of the second oscillator. The amplitude, Q-factor and frequencies reveal signatures for fluid measurement and identification. Aspects according to this disclosure also include such a vibrational transducer or a device or system comprising such a vibrational transducer.

Aspects according to this disclosure may have particular application for measuring properties of flowing viscoelastic fluids, including their use in the monitoring of viscoelastic fluids in a larger process such as a manufacturing process.

Aspects according to this disclosure further include devices and systems including one or more vibratory transducers having multiple oscillators configured to perform any of the methods described herein. For example, aspects according to this disclosure include apparatus comprising means for performing any of the methods described in this disclosure.

Aspects according to this disclosure further include computer-readable media, such as non-transitory computer-readable media, having instructions stored thereon that, when executed by a processor, cause the processor to configure a device including one or more vibratory transducers having multiple oscillators to perform any of the methods described herein.

### BRIEF DESCRIPTION OF THE DRAWINGS

The invention will be described in more detail by way of example only with reference to the accompanying drawings, in which:

FIGS. 1 to 5 illustrate vibratory transducers for use with the techniques of this disclosure;

FIG. 6 is a more detailed diagram of a vibratory transducer for use with the techniques of this disclosure;

FIG. 7 illustrates a simplified spring-mass-damper model of the vibratory transducer shown in FIG. 6;

FIG. 8 is a plot of loss factor against viscoelasticity for materials having various values of tan Δ;

FIG. 9 is a plot of frequency against viscoelasticity for materials having various values of tan Δ;

FIG. 10 is a plot of a multi-frequency signature analysis for measurements of loss factor, amplitude and frequency for various fluids over varying viscoelasticity;

FIG. 11 is a plot of loss factor against fluid stiffness and damping for base excitation;

FIG. 12 is a plot of loss factor against fluid stiffness and damping for super excitation;

FIG. 13 is a plot of loss factor against fluid damping for sub excitation;

FIGS. 17 and 18 are plots of loss factor against fluid stiffness and damping for super excitation of two different fluids, showing two different loss factor profiles;

FIG. 19 illustrates a shear wave radially propagating in a viscoelastic fluid from a curved surface;

FIG. 20 illustrates shear waves radially propagating from curved surfaces of cylinders in which one cylinder is displaced from the axis of rotation;

FIG. 21 shows a graph of measured damping factor illustrating the application of the techniques of this disclosure;

FIG. 22 illustrates a cylindrical element under lateral vibration causing a dipole wave field;

FIG. 23 illustrates laminar flow around a cylindrical element under lateral vibration;

FIG. 24 illustrates a flow chart corresponding to a method according to the techniques of this disclosure.

### DETAILED DESCRIPTION

Aspects in accordance with this disclosure concern two (or more) coupled mechanical oscillators of a vibratory transducer for immersing in a viscoelastic fluid. At least one of the mechanical oscillators is in contact with the viscoelastic fluid.

The first oscillator can be referred to as primary oscillator with natural frequency ω_{y}. The second oscillator is the secondary oscillator with natural frequency ωₓ. When the oscillators' frequencies are chosen to be similar, the primary oscillator will excite the secondary oscillator through the process of ‘base excitation’.

The viscoelastic fluid loads one (or both) oscillators with additional mass (from density), damping (viscosity), and stiffness (elasticity). The frequency response of the dual-oscillator combination is therefore modulated by the fluid properties.

By measuring the resonant frequency, amplitude, and/or loss factor of the combination, the 3 key fluid parameters of density, viscosity and elasticity can be determined.

Both the viscous and elastic forces strongly affect measured parameters in a unified monotonic way, thus providing reliable determination of complex viscosity μ*, where

$${μ}^{*} = {( {μ}^{2} + {( \frac{{G}^{′}}{ω} )}^{2} )}^{0.5} \qquad Equation 1$$

where μ′ is the dynamic viscosity and G′ is the storage modulus.

The stronger the elastic effect in the viscoelastic fluid, the greater the applicability of the techniques of this disclosure. For example, the techniques of this disclosure may be applicable for fluids having a degree of viscoelasticity corresponding to Δ<75°, Δ<60°, Δ<45°, Δ<30°, or Δ<15°, where the degree of elastic behaviour increases as A decreases from 90°, which corresponds to purely viscous behaviour. The techniques of this disclosure can be applied to fluids that are weakly elastic, such as for the range 75°<Δ<85°, or for ranges of A that are increasingly elastic, such as:
60°<Δ<75°, or
45°<Δ<60°, or
30°<Δ<45°, or
15°<Δ<30°, or
0°<Δ<15°, or
any combination of these ranges, whether the combination results in a contiguous range, such as 30°<Δ<75°, or multiple non-contiguous sub-ranges, such as the combined range represented by 30°<Δ<45° or 60°<Δ<75°.

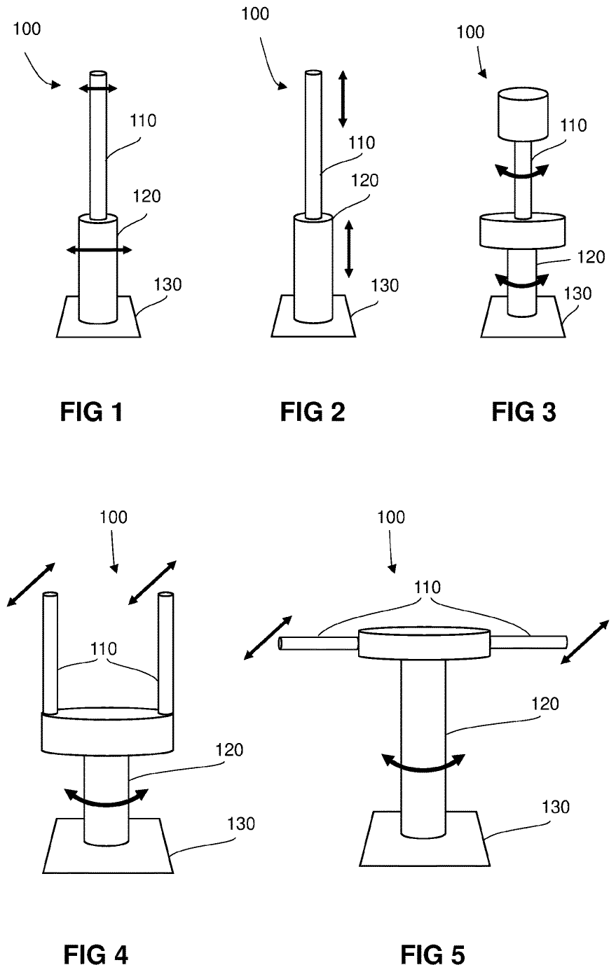

FIG. 1 illustrates a vibratory transducer 100 comprising a primary oscillator 120 and a secondary oscillator 110, both configured to vibrate in a lateral vibrational mode, illustrated by thick double-ended arrows in FIG. 1. Lateral vibration driven at the ground 130 causes the primary oscillator 120 to vibrate and the secondary oscillator 110 is coupled to the primary oscillator 120. Vibration within the fluid around the primary oscillator 120 and secondary oscillator 110 has a modulating effect on resonant frequencies, amplitudes and loss factors (or Q factors, which are reciprocals of loss factors) from which density, viscosity and elasticity of the fluid can be determined.

FIG. 2 illustrates a similar vibratory transducer 100 as FIG. 1, except that the vibrational modes are longitudinal for both the primary oscillator 120 and the secondary oscillator 110, the vibrational modes illustrated by thick double-ended arrows. The ground 130 is driven by longitudinal vibration to excite the longitudinal vibrational modes.

FIG. 3 illustrates a similar vibratory transducer 100 as FIG. 1, except that the vibrational modes are torsional for both the primary oscillator 120 and the secondary oscillator 110, the vibrational modes illustrated by thick double-ended arrows. The ground 130 is driven by torsional vibration to excite the torsional vibrational modes

FIG. 4 illustrates a hybrid vibrational transducer 100, in which the primary oscillator 120 is configured to vibrate in a torsional vibrational mode. The primary oscillator 120 comprises a shaft coupled to the ground 130 and a bob at the distal end of the shaft. The secondary oscillator 110 comprises a pair of pins extending axially from the bob of the primary oscillator 120, where the pins vibrate laterally when the primary oscillator vibrates torsionally. This is because the pins of the secondary oscillator 110 are offset from the torsional vibrational axis of the primary oscillator 120.

FIG. 5 illustrates another hybrid vibrational transducer 100, in which the primary oscillator 120 is configured to vibrate in a torsional vibrational mode. As with the transducer 100 shown in FIG. 4, the primary oscillator 120 comprises a shaft coupled to the ground 130 and a bob at the distal end of the shaft. The secondary oscillator 110 comprises a pair of pins extending radially from the bob of the primary oscillator 120, where the pins vibrate laterally when the primary oscillator vibrates torsionally.

FIG. 4 and FIG. 5 illustrate vibrational transducers 100 that are described as hybrid vibrational transducers because the primary and secondary oscillators use different vibrational modes, in this case torsional for the primary oscillator 120 and lateral for the secondary oscillator 110. Other examples may use different combinations of vibrational modes, such as torsional plus longitudinal, or lateral plus longitudinal, or even a combination of torsional, lateral and longitudinal modes.

In FIG. 4, the secondary oscillator 110 comprises pins that extend in the same direction as the torsional vibrational axis of the primary oscillator. In FIG. 5, the secondary oscillator 110 comprises pins that extend radially outward from the torsional vibrational axis of the primary oscillator. In other examples (not shown) the secondary oscillator 110 comprises pins that extend in a direction that is oblique to both the radial and axial directions of the torsional vibrational axis of the primary oscillator 120, or in a direction that has at least some tangential component.

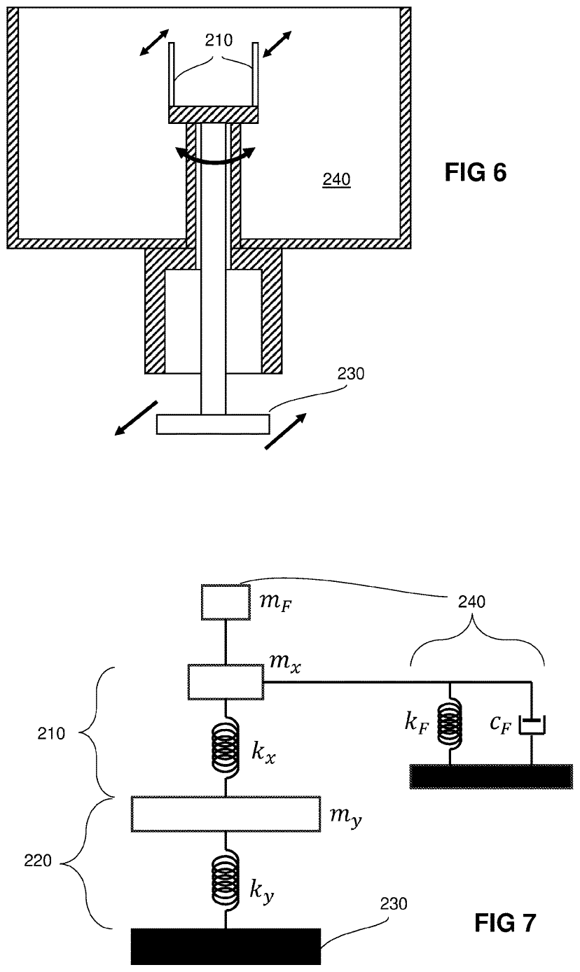

FIG. 6 illustrates a more detailed arrangement of a hybrid vibrational transducer in use, where a primary oscillator 220 undergoes torsional vibration and a secondary oscillator 210 in the form of axially extending pins undergoes lateral vibration, all within a viscoelastic fluid 240 having properties μ′, G′, and ρ, where ρ represents density. The torsional vibration of the primary oscillator is caused by vibration of a torsion bar 230 at an opposing end of the primary oscillator 220 from the secondary oscillator 210. In this example, only the secondary oscillator 210 is in contact with the fluid and configured to vibrate in the fluid. In other examples, both the primary oscillator 220 and secondary oscillator 210 are configured to vibrate in the fluid.

FIG. 7 illustrates a simplified spring-mass-damper model for the system shown in FIG. 6, in which a shaft mass and shaft stiffness of the primary oscillator 220 (i.e. a primary system) are represented by a mass m_{y} and a spring having stiffness k_{y}, the pin mass and pin stiffness of the secondary oscillator 210 (i.e. a secondary system) are represented by a mass mₓ and a spring having stiffness kₓ, the fluid mass loading is represented by an additional (added) mass mₚ coupled to the pin mass, and fluid damping and elasticity are represented by an additional damper and spring coupled to the pin mass, the additional damper having a damping coefficient cₓ and the additional spring having a stiffness k_{F}, the fluid properties shown as reference 240 in FIG. 7.

The resonant frequency (ωₓ) of the secondary oscillator is modulated by the stiffness and mass loading on the vibrating parts of the oscillator by fluid elasticity (G′) and density (φ.

The amplitude (X) of the secondary oscillator is reduced by increasing G′ and viscous damping.

The stiffness and mass of the primary system are such that the primary can oscillate at a frequency near the that of the resonant frequency of the secondary system, as well as frequencies much lower or higher than the resonant frequency of the secondary system.

As frequency of the primary system (ω_{y}) approaches the resonant frequency of the secondary system (ωₓ), it excites the secondary system through base excitation. The result is the secondary system oscillates with a higher amplitude X than the primary system Y. In other words, X/Y>1. At lower frequencies for the oscillation of the primary system, X/Y→1.

At higher frequencies of the primary system, X/Y→0.

There may be an inverse viscoelastic response. Under low μ′ and G′, the secondary oscillator is free to vibrate with amplitude X. The high amplitude X of vibration causes increased shearing and thus increased dissipated energy due to damping. This increases loss factor (i.e. reduces Q factor) of the primary system and reduces its amplitude Y.

Above a critical viscoelasticity, higher viscous or elastic loading resists the motion of the secondary oscillator, thus reducing X/Y and fluid shearing. System damping is reduced and the result is increased amplitude and reduced loss factor of the primary oscillator (increased Q factor). Viscoelasticity has reduced the effect of the secondary oscillator on the primary oscillator.

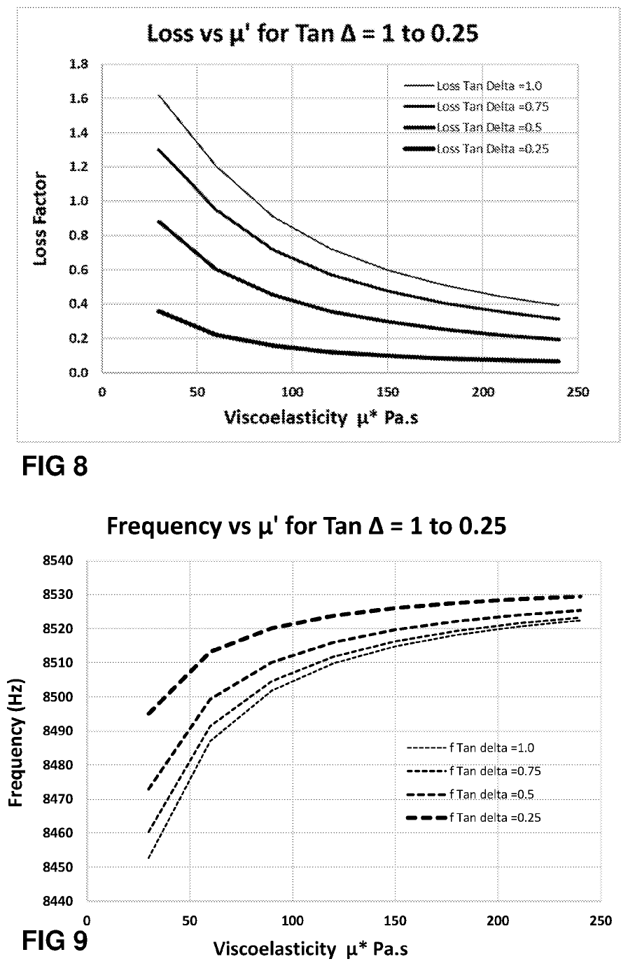

The inverse response to viscous and elastic loading by varying tan Δ is shown in FIG. 8. From this plot, it can be seen that an increase in elastic loading (which causes a decrease in tan Δ), shows as a decrease in loss factor for a given complex viscoelasticity.

Under base excitation, loss factor (and 1/amplitude) follow an inverse viscoelastic response.

Outside of base excitation, where the frequency of the primary system is much lower than the resonant frequency of the secondary system, the well-known relationship exists where increasing viscoelastic loading provides a directly proportional response of loss factor and 1/amplitude.

These techniques may be further enhanced by considering a difference or ratio (or some other comparison) of loss or amplitude ratio for a frequency of base excitation and a frequency far away from base excitation (e.g. where the frequency of the primary system is much lower than the resonant frequency of the secondary system). This amplifies the viscoelastic response while having the benefits of differential measurement, which can reduce or nullify common-mode noise or measurement aberrations.

In addition, the combined output is monotonic with complex viscosity and has increased sensitivity relative to techniques that do not combine measurements for multiple frequencies such as a base excitation frequency and a frequency far from base excitation.

In considering frequency vs. viscoelasticity, the secondary oscillator has a frequency dependence on fluid loading, essentially due to the fluid storage modulus, G′. Frequency of the primary oscillator can thus be seen to increase with fluid elasticity.

This is particularly true where the oscillator makes use of geometrically damped elements as described in UK patent application no. GB2207881.0, filed 27 May 2023, and further discussed in the present disclosure. For example, a vibratory transducer may comprise one or more elongate members. The pins of the examples shown in FIG. 4 and FIG. 5 may be elongate members. Such elongate members may be characterised by a width, a half width that is equal to half of the width, and a length that is greater than the width, wherein the half width is less than a propagation depth of a shear wave in the fluid at the vibration frequency of the elongate members, more preferably less than 50% of the propagation depth.

This provides an additional independent measurement of fluid elasticity based on measuring the frequency change of the primary oscillator. This is demonstrated in FIG. 9, which shows frequency vs. μ′ for tan Δ from 1 to 0.25.

These techniques may further be applied to a multi-frequency signature analysis, by which a fluid might be identified from signature of combination measurements made at multiple frequencies.

To explain, the secondary resonator system's stiffness, mass and damping are loaded by the fluid elasticity, density and viscosity respectively. The modulation of the stiffness, mass and damping of the oscillator by the fluid alters the response of the resonant elements. This response also varies at different frequencies. There is therefore an observed strong variation in the measured amplitude, frequency and loss factor for different primary excitation frequencies depending for different fluids. Many fluids can be identified by their density and viscoelasticity e.g. polymer melts. By mapping the frequency response of polymers, for example, in relation to their amplitude, frequency and loss factor, it is possible to correlate their signature traits with the measured values and thereby identify the material under measurement.

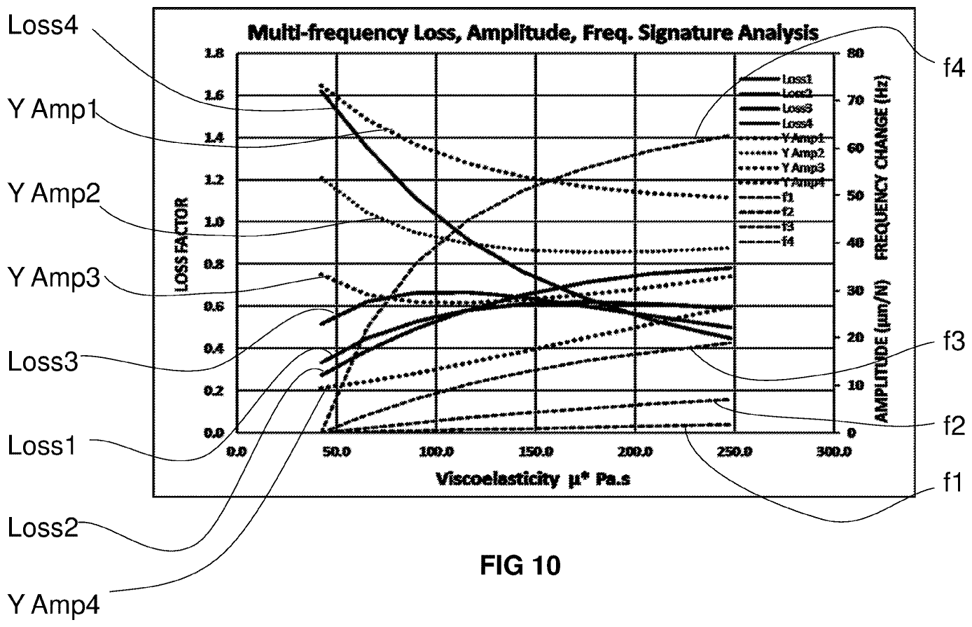

FIG. 10 illustrates a multifrequency signature analysis for four different fluids, 1 to 4, where the loss factor, amplitude (μm/N) and frequency change (Hz) are determined over multiple values. Each of the four fluids has a different profile, varying with complex viscosity elasticity (μ*), i.e. viscoelasticity. From the different profiles, measurements of loss factor and amplitude and frequency change for an unknown fluid can be used to find a profile that best matches the measurements and estimate the unknown fluid.

For further insight into the behaviour discussed above, the simplified spring-mass-damper model of FIG. 7 can be analysed to show that the energy dissipation, or loss factor L is given by:

$$L = \frac{K {c}_{x} {ω}_{y}}{{( {k}_{x} {ϵ}_{ω} + {k}_{F} )}^{2} + {( {c}_{x} {ω}_{y} )}^{2}} , \qquad Equation 2$$

where:
ω_{y} is the base (or primary element) frequency of vibration,
ωₓ is the secondary element resonant frequency,
k_{y} is the primary system stiffness,
m_{y} is the primary system mass,
kₓ is the secondary system stiffness,
mₓ is the secondary system mass,
c_{F} is the fluid damping coefficient,
k_{F} is the fluid damping stiffness,
m_{F} is the fluid damping added mass,
K is a system constant, and
∈_{ω} is a frequency factor equal to:

$$1 - {ω}_{y}^{2} / {ω}_{x}^{2} .$$

The ∈_{ω} frequency factor has an important effect on the measured loss factor (or Q factor) in response to fluid properties.

As the frequency of vibration of the primary system approaches the resonant frequency of the second system, i.e. ω_{y}→ωₓ, then ∈_{ω}→0. In such arrangements, the dependency of the denominator in Equation 2 on kₓ reduces or even disappears. The loss factor L may be approximated by the following expression:

$$L = \frac{K {c}_{x} {ω}_{y}}{{k}_{F}^{2} + {( {c}_{x} {ω}_{y} )}^{2}} , \qquad Equation 3$$

FIG. 11 illustrates a plot of L against cₓ or k_{F} in these circumstances, i.e. when ∈ω→0. It can be seen from FIG. 11 that L decreases monotonically with increasing cₓ. L also decreases monotonically with increasing k_{F}. Thus by operating the vibratory transducer with ω_{y} equal to ωₓ, the loss factor is found to vary monotonically with the damping coefficient of the fluid, which is a function of μ′. Also, the loss factor is found to vary monotonically with the stiffness of the fluid, which is a function of G′. In this way, via appropriate lookup tables or approximation functions obtained through calibration, the dynamic viscosity of the fluid and G′ the storage modulus of the fluid can be determined. The monotonicity of this function is important because it means that a measured value of L allows cₓ and/or k_{F} to be determined. In addition, the sensitivity to k_{F} is increased, since it does not depend on k_{F} and kₓ in combination.

While kₓ (and its quadratic interaction with k_{F}) only disappears from Equation 2 when ∈ω is equal to zero, substantial independence from kₓ is obtained when ∈_{ω} is close to zero, i.e. when ωₓ is similar to ω_{y}. Even if ωₓ is not equal to ω_{y}, a monotonically decreasing relationship between L and k_{F} and/or cₓ may be obtained provided ωₓ is sufficiently similar to ω_{y}. The excitation of the primary system (first oscillator) may be at a frequency that is near (e.g. within 50%, 40%, 30%, 20%, 10%, 5%, 2%, or 1%) to a natural frequency of the secondary system (second oscillator). The primary system may be configured to have a natural frequency that is near to a natural frequency of the secondary system (e.g. within 50%, 40%, 30%, 20%, 10%, 5%, 2%, or 1%). Preferably, one or both of the excitation frequency and natural frequency of the primary system is/are within 20% of the natural frequency of the secondary system, more preferably within 10%, more preferably still within 5%, even more preferably still within 2%, or even within 1%. On the other hand, there may be advantages in not operating the primary system at exactly the same frequency as the natural frequency of the secondary system, e.g. not within 0.1%, 0.5% or 1% of the natural frequency of the secondary system. In the context of the present disclosure, the arrangement where ωₓ is similar to ω_{y} (ω_{y}→ωₓ) may be referred to as ‘base excitation’.

A further simplification of Equation 3 is found for Newtonian fluids, where k_{F} is equal to zero. For Newtonian fluids where ω_{y}→ωₓ, the loss factor L may be expressed as:

$$L = \frac{K}{{c}_{x} {ω}_{y}} , \qquad Equation 4$$

In other words, there exists an inversely proportional relationship between L and cₓ. This relationship is monotonically decreasing in the fashion illustrated in FIG. 11, and so base excitation offers for measurement of damping (viscosity) of Newtonian fluids the same or better monotonicity advantages as Equation 3 does for viscoelastic fluids.

If the primary system is vibrated at a frequency beyond the resonant frequency of the second system, i.e. ω_{y}>ωₓ, then ω_{y}/ωₓ>1, then ∈_{ω}<0, then kₓ∈_{ω}<0. In the context of this disclosure, this arrangement is termed ‘super excitation’. In these circumstances, where L does not simplify, the loss factor is given by Equation 2.

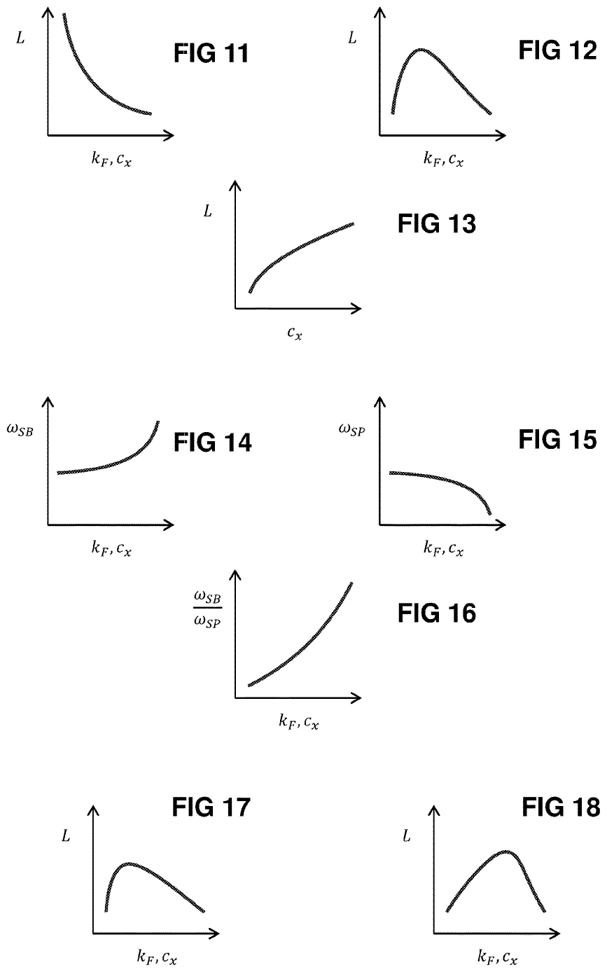

FIG. 12 illustrates a plot of L against cₓ or k_{F} for super excitation, i.e. when ω_{y}>ωₓ. It can be seen from FIG. 12 that L exhibits a more complex relationship with cₓ and k_{F} than with the base excitation shown in FIG. 11. The loss factor plotted against cₓ or k_{F} has a maximum value and is multi-valued for cₓ or k_{F} either side of the peak. The maximum value of L occurs for a frequency factor ∈_{ωm} where kₓ∈_{ωm}=k_{F}. Equivalently, the value of ω_{y} to achieve the maximum is given by the expression:

$${ω}_{y m} = {ω}_{x} \sqrt{1 - \frac{{k}_{F}}{{k}_{x}}} \qquad Equation 5$$

The fact that L does not vary monotonically with cₓ or k_{F} for super excitation does not mean that this mode is unusable for measurements purposes. For example, if approximate knowledge of cₓ or k_{F} is available, then the side of the peak upon which the measured value of L resides can be determined based on the approximate knowledge of cₓ or k_{F}. Such approximate knowledge may derive from measurements made from additional measurement techniques or be based on appropriate selection of transducer properties (geometry, stiffness, etc.) for a given fluid measurement application to ensure that the peak in L lies outside of a intended working range of fluid properties.

For super excitation with low values of cₓ, the expression for the loss factor simplifies to Equation 6 below.

If the primary system is vibrated at a frequency below the resonant frequency of the second system, i.e.

$${ω}_{y} < {ω}_{x} , then \frac{{ω}_{y}}{{ω}_{x}} < 1 , then {ϵ}_{ω} > 0 .$$

If it is further assumed that (kₓ∈_{ω})²>>(cₓω_{y})², then the loss factor may be expressed as:

$$L = \frac{K {ω}_{y} {c}_{x}}{{N}_{L A R G E}} \qquad Equation 6$$

where N_{LARGE} is a large number. In these circumstances, the loss factor's monotonic property is not affected by the elasticity of the fluid. In the context of this disclosure, this arrangement is termed ‘sub excitation’.

Sub excitation is illustrated in FIG. 13, which shows a relationship between L and cₓ where L increases monotonically with cₓ, independently of k_{F}. This configuration is equivalent to classical single-resonator damping. Essentially, the second resonator is ‘riding’ the vibrations of the first oscillator but is not itself separately excited; the vibration frequency at which the first resonator is driven is too far below the resonant frequency of the second resonator.

Based on these equations, the resonator geometries of the primary and secondary systems can be selected for different frequency conditions, whether base excitation, super excitation, or sub excitation. It is noted that ωₓ varies with the fluid mass and stiffness loading, which is a function of resonator shape and fluid density and elasticity. The secondary resonator's natural frequency is given by the following expression:

$${ω}_{x} = \sqrt{\frac{{k}_{x} + {k}_{F}}{{m}_{x} + {m}_{F}}} \qquad Equation 7$$

For base excitation, ω_{y}≈ωₓ. With this arrangement, a measurement of L can be used to determine k_{F} and/or cₓ.

For super excitation, ω_{y}=nωₓ, where n is greater than 1. For example, n may be greater than 1.5, or greater than 2. With this arrangement, a measurement of L can be used to determine k_{F} and/or cₓ.

For sub excitation, ω_{y}=nωₓ, where n is less than 1. For example, n may be less than or equal to 0.5 or less than or equal to 0.25. With this arrangement, a measurement of L can be used to determine cₓ.

From Equation 7, we can obtain an expression for the fluid's added mass:

$${m}_{F} = \frac{{k}_{x} + {k}_{F}}{{ω}_{x}^{2}} - {m}_{x} \qquad Equation 8$$

Since the added mass is proportional to the fluid's density, we can obtain an expression for the density as follows:

$$ρ = A {m}_{F} = A ( \frac{{k}_{x} + {k}_{F}}{{ω}_{x}^{2}} - {m}_{x} ) \qquad Equation 9$$

for some calibration constant A.

In some examples, one or more vibratory transducers are employed to operate in more than one of these modes, i.e. more than one of: base excitation, super excitation and sub excitation.

In an example, a first vibratory transducer is employed to operate in a first one of these modes and a second vibratory transducer is employed to operate in a second one of these modes that is different to the first mode. For example, the first vibratory transducer may operate in the base excitation mode and the second vibratory transducer may operate in the sub excitation mode. Alternatively, the first vibratory transducer may operate in the super excitation mode and the second vibratory transducer may operate in the sub excitation mode. In this way, multiple vibration measurements (loss factor, Q factor, frequency, amplitude, etc.) may be made of a fluid. These vibration measurements may be combined to determine properties of the fluid.

In some examples, a vibratory transducer may operate in multiple modes. For example, a vibratory transducer may operate in two of or all three of: base excitation, super excitation, and sub excitation. The vibratory transducer may make a first vibration measurement in one of base excitation, super excitation, and sub excitation, and may make a second vibration measurement in a different one of base excitation, super excitation, and sub excitation, and may optionally make a third vibration measurement in the remaining one of base excitation, super excitation, and sub excitation. In this way, multiple vibration measurements (loss factor, Q factor, frequency, amplitude, etc.) may be made of a fluid. These vibration measurements may be combined to determine properties of the fluid.

The use of more than one of base excitation, super excitation, and sub excitation in combination may allow both cₓ and k_{F} to be efficiently or straightforwardly determined.

For example, the use of sub excitation may determine cₓ from a measurement of L. With base excitation, L is monotonically dependent on k_{F} and cₓ, but cₓ can separately be determined via sub excitation, rendering it straightforward to determine k_{F} given knowledge of L and cx via lookup tables, calibrated approximation functions, etc. The same is also true of other combinations of base, super and sub excitation, although determining k_{F} and cₓ may require solving a system of equations corresponding to each of the different measurements of L by each technique in combination, or the performing of numerical equation solving techniques such as by iterative methods. For example, super excitation and base excitation can both yield measurements of L from which kₓ and cₓ can be determined via lookup table or approximation function from the two measurements or from substitution measurements of L at different frequencies into Equation 2. If a fluid's elasticity is sufficiently low relative to its elasticity (i.e. A is sufficiently high), then N_{LARGE} can be treated as wholly independent of fluid stiffness, in which case sub excitation and super excitation together allow for cₓ to be determined directly, leaving the determining of k_{F} from the super excitation measurement more straightforward.

It is not strictly necessary however to use more than one of base excitation, super excitation, and sub excitation in combination to determine material properties such as cₓ or k_{F}. For example, if the fluid's elasticity or viscosity may already be known or may be determined by any other technique that will be known to the skilled reader, such as by rotational viscometers, falling sphere viscometers, capillary viscometers, shear rheometers or acoustic rheometers.

Thus it is not necessary to determine cₓ or k_{F} by way by way of a combination of base, sub and super excitation as described herein and techniques according to this disclosure may make use of a single one of base excitation or super excitation.

Measurements made using multiple different excitation modes (base/sub/super excitation) may provide further advantages. In particular, they may be used in combination to cancel common-mode errors such as noise in measurement results.

As an example, dividing Equation 6 by Equation 3, provides the following expressions, where the base excitation frequency is ω_{y} and the sub excitation frequency is nω_{y}, where n is less than 0.5:

$$\frac{{L}_{s u b}}{{L}_{b a s e}} = \frac{{k}_{F}^{2} + {( {c}_{x} {ω}_{y} )}^{2}}{K {c}_{x} {ω}_{y}} \cdot \frac{K {c}_{x} n {ω}_{y}}{{N}_{L A R G E}} \qquad Equation 10$$

$$\frac{{L}_{s u b}}{{L}_{b a s e}} = \frac{n ( {k}_{F}^{2} + {( {c}_{x} {ω}_{y} )}^{2} )}{{N}_{L A R G E}} \qquad Equation 11$$

$$\frac{{L}_{s u b}}{{L}_{b a s e}} = A ( {k}_{F}^{2} + {( {c}_{x} {ω}_{y} )}^{2} ) \qquad Equation 12$$

where L_{base} is a measurement made at a base excitation frequency ω_{y}, L_{sub} is a measurement made at a sub excitation frequency n ω_{y}, where n<0.5 for example, and A is some constant. If the sub excitation and super excitation measurements are made using different transducers then the particular values of K will likely be different but any difference is incorporated into the eventual constant A in Equation 12.

Therefore Equation 12 provides a useful expression where the value obtained from two measured loss factors is strongly dependent on a fluid stiffness-viscosity function given by

$${k}_{F}^{2} + {c}_{x}^{2} {ω}_{y}^{2} .$$

Moreover, as a result of the ratiometric processing of the measured loss factors, any systematic errors or noise that exist in the measurements of L_{sub} and L_{base} cancel favourably through the division, giving a result in which such errors or noise are reduced or eliminated. Such errors or noise may also be reduced by obtaining ratios of other measurements, such as loss factors for sub excitation and super excitation or loss factors for base excitation and super excitation. Moreover, such errors or noise may also be reduced by obtaining a difference between loss factors obtained from different excitations, such as a difference between loss factors for sub excitation and base excitation, a difference between loss factors for sub excitation and super excitation, or a difference between loss factors for super excitation and base excitation. The reduction of errors or noise may further be improved by obtaining a weighted difference, i.e. multiplying one or both loss factors by appropriately chosen (e.g. by an optimisation process) scaling factors before obtaining the difference to reduce or minimise systematic errors or noise.

While the analysis is presented above in terms of the loss factor, corresponding equations can be produced in terms of a Q factor, with trends inverted due to the reciprocal relationship between loss factor and Q factor. Other relationships can be determined for measurements of amplitude and resonant frequency of the system.

For example, analysis provides approximate equations for the natural frequencies of the coupled oscillators at sub and super excitation as follows:

$${ω}_{S B} = {a}_{1} - \sqrt{{b}_{1} {k}_{F} / ( {k}_{F}^{2} + {c}_{x}^{2} )} \qquad Equation 13$$

$${ω}_{S P} = {a}_{2} + \sqrt{{b}_{2} {k}_{F} / ( {k}_{F}^{2} + {c}_{x}^{2} )} \qquad Equation 14$$

where ω_{SB} is the natural frequency at sub excitation and ω_{SP} is the natural frequency at super excitation, and a₁, a₂, b₁ and b₂ are system constants.

In both of these cases, the modulation of frequency with cₓ and k_{F} is clear.

FIG. 14 is a plot of natural frequency for sub excitation against k_{F} and cₓ in accordance with Equation 13, and shows a monotonic response of natural frequency with k_{F} and cₓ, where ω_{SB} increases with increasing k_{F} and cₓ.

FIG. 15 is a plot of natural frequency for super excitation against k_{F} and cₓ in accordance with Equation 14, and shows a monotonic response of natural frequency with k_{F} and cₓ, where ω_{SP} decreases with increasing k_{F} and cₓ.

Therefore the measurements of ω_{SB} and ω_{SP} allow k_{F} and cₓ to be determined, whether by approximation function, lookup table, etc., or by the solution of Equation 13 and Equation 14 together.

FIG. 16 is a plot of ω_{SB}/ω_{SB} against k_{F} and cₓ in accordance with Equation 13 and Equation 14, and it also shows a monotonic response of natural frequency with k_{F} and cₓ. Determining ω_{SB}/ω_{SB} (or its inverse) may offer particular advantages because of the antiphase variation in w for sub and super excitation based on changes in k_{F} and cₓ. In particular, it allows these measurements of frequency to be combined in order to remove common-mode errors. For example, fluid temperature may have a significant effect on natural frequency of a transducer vibrating in that fluid. But the temperature effect on natural frequency is a change in frequency in the same direction for both ω_{SB} and ω_{SP} for a given change. With the antiphase variation in ω, if a ratio of ω_{SB} and ω_{SP} is determined, then the effect of temperature change is cancelled out to at least some degree, so the quantity ω_{SB}/ω_{SP} is less sensitive to common-mode error effects such as temperature variation than either measurement is separately. Moreover, because ω_{SB} and ω_{SP} are in antiphase together, it increases the sensitivity to changes in k_{F} and cₓ. Thus the combination of ω_{SB} and ω_{SP} in the form of a ratio offers amplified sensitivity to k_{F} and cₓ with reduced noise through cancellation of common-mode effects. This applies regardless of whether the ratio is ω_{SB}/ω_{SP} or ω_{SP}/ω_{SB}.

This approach offers a further advantage in that it does not require knowledge of the natural frequency of the second oscillator with any precision. Sub excitation requires a much lower frequency than the expected secondary oscillator frequency. Similarly, super excitation requires a much higher frequency. In practice, it is simple to estimate frequencies that are much higher and lower than a very approximate guess of the second oscillator's frequency.

In addition, the analysis is presented above in for the particular mass-spring-damper model shown in FIG. 7, which is a simplification made for analysis of the particular arrangement shown in FIG. 6, these simplifications neglecting any mechanical damping of the oscillators themselves and neglecting any continuum mechanics of the oscillators, treating them as point masses connected via springs. The skilled reader will recognise that the techniques of this disclosure are not inseparably bound to the particular equations set out above that correspond to this particular model but instead represent a broader trend or behaviour for mechanically coupled multi-oscillation of vibratory transducers of other designs and configurations. The analysis may further be extended for vibratory transducers comprising three or more oscillators (which are in accordance with the techniques of this disclosure) wherein a third oscillator may be coupled to the primary oscillator in parallel with the second oscillator (where the spring and mass properties may be combined with those of the second oscillator to yield the same equations as above) or where a third oscillator is coupled to the second oscillator, which may yield a more complicated frequency response but allow the same general concepts of base, super and sub excitation as described above for each of the second and third oscillators.

As mentioned previously, the use of resonators in the form of narrow elongate members as described in UK patent application no. GB2207881.0, filed 27 May 2023, and further described below, may be favourable because the radial/geometric radiator attributes yield high values of damping cₓ and fluid stiffness k_{F} combined with low contact area with the fluid. A low contact area with the fluid may be advantageous particularly in applications in which the vibratory transducer in in a flowing fluid because it reduces the amount of material adhered to the fluid-contacting surface, which may cause the transducer to be quicker at detecting changes in properties of the flowing fluid.

The natural variation of ωₓ with fluid density and elasticity between different fluid materials create different loss responses depending on the material. This creates, for each material, a signature response that can be used to identify the material being measured. This is particularly true for polymers (e.g. polymer melts), which are characterized by different density and elastic properties.

FIGS. 17 and 18 show plots of loss factor for super excitation for two different materials. It can be seen that the plots are different. Based on only a small number of measurements of loss factor at different frequencies (e.g. multiple super excitation frequencies, or a combination of super excitation and base excitation frequencies), it is possible to determine which of these two loss factor curves characterize the material, and thus determine which of the two different materials corresponds to the material being measured, or to estimate the relative amounts of each material in a sample being tested.

In practice, the loss factor curve for a material may be characterised by one or more values, such as the location of the peak of the loss factor curve or the ratio of the location of that peak to some other material property such as elasticity or density. A user may obtain such signature or characterising values for each of a plurality of different materials and compare measurements from a fluid under examination to a stored data set of signature values for each of the plurality of materials to identify the material under examination. The result may exactly correspond to one of the stored values, indicating that particular material, or may be a mixture between two stored values, which may indicate a mixture of materials, the exact value indicative of the relative amounts of materials in the mixture.

In a configuration in accordance with the techniques of this disclosure, a vibratory transducer includes a shaft and a plurality of elongate members. If the vibratory transducer comprises a bob, then the elongate members may be connected to the vibratory transducer at the bob. Alternatively or additionally, the vibratory transducer may comprise elongate members connected to the vibratory transducer at the shaft. A plurality of elongate members are spaced around the circumference of the shaft or bob, extending outward from the shaft or bob in a wholly radial direction or in a direction with a radial component and an axial component, or in a wholly axial direction (that is not colinear with a longitudinal axis of the shaft/bob). The plurality of elongate members may be distributed evenly around the circumference, which may mitigate or avoid any disturbance in the centre of mass relative to the longitudinal axis, or may be distributed unevenly around the circumference. The plurality of elongate members may be connected to the shaft or bob at the same axial position along the length of the shaft or bob, or may be connected at different axial positions, e.g. in a helical pattern around the exterior surface of the shaft or bob.

If the plurality of elongate members extend from the shaft or bob in a wholly or partially axial direction, then the elongate members may include spacing supports from an outer surface of the shaft or bob to provide a radial offset to the elongate members. Alternatively, the plurality of elongate members may extend from an end of the shaft or bob, such as distributed in a circle around the longitudinal axis and extending from the end of the shaft or bob. The end of the shaft or bob may be flat, curved, conical or have some other profile.

The elongate members may have a width and half width such that geometric damping (monopole behaviour) may take place around the elongate members during vibration of the vibratory transducer. The vibration of the vibratory transducer may be torsional about the longitudinal axis of the shaft.

Alternatively, the one or more elongate members may be defined geometrically in a way that is independent of geometric damping (monopole behaviour), where geometric damping may circumstantially apply depending on the properties of the fluid, i.e. its shear wave penetration depth. For example, the one or more elongate members may have a width or diameter of between 0.1 mm and 5 mm, preferably between 0.2 mm and 4 mm, more preferably between 0.3 mm and 3 mm, more preferably between 0.5 mm and 3 mm, more preferably between 0.8 mm and 3 mm. For example, particularly preferred diameters/widths may be between approximately 1 mm and 2 mm (e.g. between 0.9 mm and 2.2 mm if ‘approximately’ is taken to mean±/−10% to each end of the range. Alternatively or additionally, an aspect ratio for the elongate member, the ratio of length: width may be greater than 3:1, greater than 5:1, greater than 10:1 or even greater than 20:1. Therefore an example elongate member may have a width or diameter of 1 mm and a length of 10 mm, or a width or diameter of 2 mm and a length of 15 mm, purely by way of example. Such dimensions may have application in a wide range of fluids of interest.

The vibratory transducer may comprise two or more elongate members, such as three, four, five, six, seven, eight, nine, ten or more elongate members. The elongate members may have constant cross sections along their lengths (such as a cylindrical elongate member or an elongate member having a square/rectangular, rounded square/rectangular (e.g. in the form of a superellipse), triangular or elliptical cross section) or may have varying cross sections shapes or sizes along their lengths, such as i) a cone of linearly decreasing cross-section area with increasing distance from the shaft or bob, or ii) stepped variations in size or shape (e.g. stepped decrements in size) with increasing distance from the shaft or bob.

In a particular configuration, a vibratory transducer comprises a shaft configured for torsional vibration, the shaft having a proximal end at which the vibrations are driven and a distal end. At or close to the distal end of the shaft (e.g. nearer to the distal end than the proximal end, or within a final quarter of the fluid-contacting length of the shaft, or within a final tenth of the fluid-contacting length of the shaft, or within a final twentieth of the fluid-contacting length of the shaft), a plurality of elongate members extend radially outward from the shaft at a common axial position along the length of the shaft. Eight elongate members are distributed evenly around the circumference of the shaft at 45° increments. In another particular configuration, a bob is present at the distal end of the shaft and the eight elongate members extend radially outward from bob. Other configurations comprise more or fewer elongate members, distributed evenly around the shaft/bob or distributed unevenly. For example, one configuration comprises six elongate members distributed evenly around the circumference of the shaft.

In another particular configuration, a vibratory transducer includes a shaft and a plurality of elongate members that are aligned axially with the longitudinal axis of the shaft but are not colinear with the longitudinal axis of the shaft. At a distal end of the shaft there is a bob. The bob has the form of a cylinder that is coaxial with the longitudinal axis of the shaft but has a larger radius than the shaft. The plurality of elongate members extend axially outward from an end of the bob, each connected to the end of the bob at the same radial offset from the longitudinal axis and distributed evenly around the longitudinal axis. The plurality of elongate members comprise eight elongate members that are distributed evenly around the longitudinal axis at 45° increments. The vibratory transducer is configured to vibrate torsionally about the longitudinal axis. Other configurations comprise more or fewer elongate members, distributed evenly around the longitudinal axis or distributed unevenly. For example, one configuration comprises six elongate members distributed evenly around the longitudinal axis.

In such configurations, the shaft/bob may represent a first oscillator and the elongate members may (together) represent a second oscillator in accordance with the techniques of this disclosure.

Some explanation of geometric damping and elongate members employing geometric damping is presented below, wherein a purely viscous fluid is first considered, followed by a viscoelastic fluid.

For a purely viscous fluid, the propagation depth of a shear wave is given by the expression:

$${x}_{0 , μ} = \sqrt{\frac{2 {μ}^{′}}{ω ρ}} , \qquad Equation 15$$

The decreasing amplitude of the wave caused by the viscosity creates a shear stress, τₛᵤ, at the vibrating surface that is a product of the rate of change of velocity at the surface (i.e. the shear rate \dot{γ}_{μ}) and the fluid viscosity, μ′, given by the following expression:

τ_{Sμ}=\dot{γ}μ. Equation 16

The shear rate \dot{γ}_{μ}, at the oscillating surface caused by wave attenuation can be determined by differentiating an expression for the wave velocity with respect to the distance from the surface, and evaluating the expression at the surface, leading to the following expression:

$${\dot{γ}}_{μ} = - {V}_{0} α = - \frac{{V}_{0}}{{δ}_{μ}} = - {V}_{0} \sqrt{\frac{ω ρ}{2 {μ}^{′}}} , \qquad Equation 17$$

where V₀ is a shear velocity at the oscillating surface.

The shear rate due to viscous attenuation is proportional to the square root of the frequency and proportional to the square root of the density and proportional to the square root of the reciprocal of the viscosity.

Therefore, the shear stress at the surface (which is a product of the viscosity and shear rate at the surface) is non-linear:

$${τ}_{S μ} = - {V}_{0} \sqrt{\frac{ω ρ}{2 {μ}^{′}}} {μ}^{′} = - {V}_{0} \sqrt{\frac{{μ}^{′} ωρ}{2}} . \qquad Equation 18$$

In addition to viscous effects, a fluid may show elastic behaviour, which is dependent on the storage modulus, G′. The presence of G′ reduces the loss tangent, tan Δ.

For a purely viscous fluid, tan Δ=∞. With increased elastic behaviour the fluid becomes less lossy, allowing the wave to propagate further into the fluid. Taking elasticity into account, the propagation depth is given by:

$${x}_{0} = \sqrt{\frac{2 {μ}^{′}}{ω ρ}} \cdot ( \frac{1}{sin \frac{Δ}{2}} \cdot \sqrt{\frac{1}{2 sin Δ}} ) = \sqrt{\frac{2 {μ}^{′}}{ω ρ}} \cdot F ( Δ ) \qquad Equation 19$$

in which 1/(sin(Δ/2)\sqrt{(2 sin Δ)}) is a quantity that scales the propagation depth due to the fluid's elastic behaviour. This quantity is also equal to 1/(sinΔ\sqrt{(1−cosΔ)}).

For a purely viscous fluid, A is equal to 90° and so the scaling quantity given by

$$1 / ( sin ( \frac{Δ}{2} ) √ ( 2 sin Δ ) )$$

(or equivalently 1/{square root over ((sinΔ(1−cosΔ)))}) viscous propagation depth, δ_{μ}, is recovered. Thus it is appropriate to refer to a viscoelastic propagation depth using this expression even for fluids that exhibit little or no viscoelasticity.

For values of Δ less than 90°, the scaling quantity is greater than 1 and so the propagation depth is increased relative to the purely viscous propagation depth.

The shear rate at the oscillating surface due to both viscosity and elasticity is given by the expression:

$${\dot{γ}}_{μ {G}^{′}} = - \frac{{V}_{0}}{{δ}_{μ , {G}^{′}}} = - {V}_{0} sin \frac{Δ}{2} \sqrt{\frac{ρω sin Δ}{{μ}^{′}}} . \qquad Equation 20$$

The shear stress at the oscillating surface due to both viscosity and elasticity is given by the expression:

$${τ}_{S μ {G}^{′}} = {\dot{γ}}_{μ {G}^{′}} {μ}^{′} = - {V}_{0} sin \frac{Δ}{2} \sqrt{ρ ω {μ}^{′} sin Δ} . \qquad Equation 21$$

The shear stress is a non-linear function of the fluid viscosity, fluid density, frequency and storage modulus (via the loss tangent). As the elasticity G′ increases, tan Δ decreases, Δ decreases from a maximum of π/2, and both sin Δ and sin Δ/2 decrease, and so the damping shear stress is reduced as the elasticity G′ increases. This explains why viscoelastic fluids show reduced damping compared with Newtonian fluids of ‘similar’ viscosity.

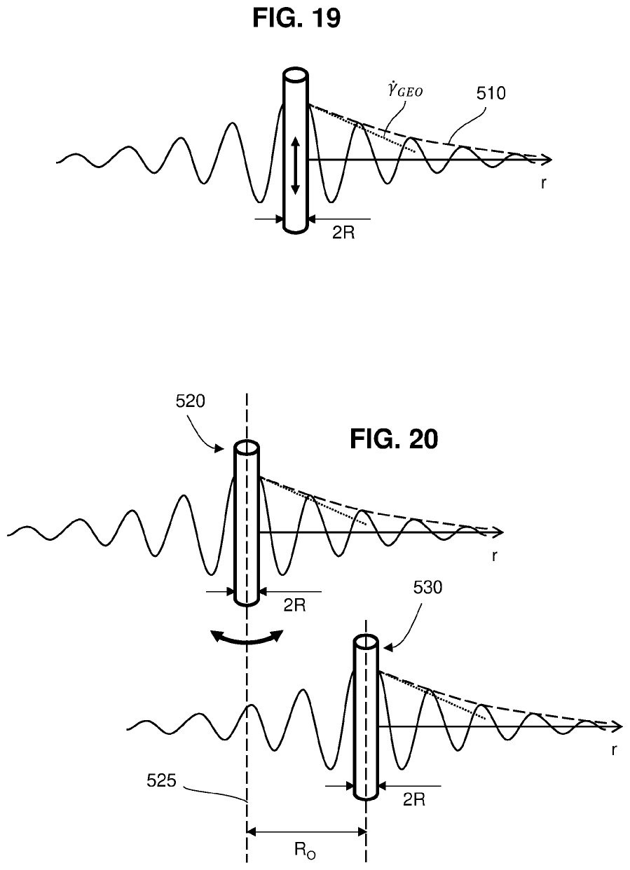

FIG. 19 illustrates a shear wave radially propagating in a viscoelastic fluid from a curved surface with radius R. While a viscoelastic fluid is relatively lossless over a short distance, FIG. 19 shows the amplitude decreasing because the potential energy of each wave peak has to be maintained as the radial distance increases, the energy spread out over an increasing circumferential length (2πr). A line 510 of constant potential energy is shown in FIG. 19. The distribution of energy over the increasing circumferential length leads to a reduced energy per unit volume and therefore a smaller peak height. This attenuation of amplitude due to geometric considerations appears similar to damping although it does not itself dissipate energy.

The change in height causes a decrease in velocity that is proportional to 1/r and this change of velocity gives rise to a shear rate, \dot{γ}_{RAD}, which combines with the viscosity to create a shear stress, τ_{RAD}, which will have a component in phase with the surface velocity, which causes energy to be dissipated. This effect is termed ‘geometric damping’ herein.

If, instead of a planar surface oscillating, a cylindrical surface of radius R is oscillating, an expression for the velocity of a radial shear wave at a location r from the central axis of the cylinder may be obtained and itself differentiated with respect to r to obtain the radial shear rate:

$${\dot{γ}}_{r} = - {V}_{r} ( \frac{1}{r} + \sqrt{\frac{ω ρ}{μ}} {e}^{i ϕ} ) = - {V}_{r} ( \frac{1}{r} + \frac{1}{{δ}_{μ {G}^{′}}} ) \qquad Equation 22$$

where Vᵣ is a shear velocity at the surface, φ is a phase adjustment angle given by tan⁻¹ (β/α) and equal to π/2−Δ/2, where β is the wavenumber of the propagating wave (i.e. 2π/λ, where λ is a wavelength of the propagating wave).

The shear stress at the cylindrical surface, where r=R, is then given by the expression:

$$\begin{matrix}{τ}_{S μ {G}^{′}} = {\dot{γ}}_{μ {G}^{′}} {μ}^{′} = - {V}_{r} ( \frac{1}{R} + \frac{1}{{δ}_{μ {G}^{′}}} ) {μ}^{′} \\ = - {V}_{r} ( \frac{1}{R} + \sqrt{\frac{ω ρ}{\vert μ \vert}} \cdot {e}^{i ϕ} )\end{matrix} \qquad Equation 23$$

The 1/R term is an in-phase shear gradient. The shear rate for this component is in phase with velocity for any degree of viscoelasticity. The 1/δ_{μG}, term is an out-of-phase shear gradient. The shear rate for this component is out of phase by φ, which depends on the degree of viscoelasticity. The phase adjustment angle represents the angle between shear stress and velocity. A shear stress that is in phase with velocity dissipates energy.

For values of R much less than δ_{μG}′, the in-phase portion dominates and the shear rate becomes less dependent or even independent of viscosity, density, frequency and storage modulus (through tan Δ/2, which is a function of G″). If 1/δ_{μG}′ is negligible compared with 1/R, then the shear stress at the cylindrical surface is given by the expression:

$${τ}_{S μ {G}^{′}} = - \frac{{V}_{r} {μ}^{′}}{R} . \qquad Equation 24$$

For values of R much greater than δ_{μG}′, the out-of-phase portion dominates and the shear rate becomes increasingly dependent on non-linear functions of viscosity, density, frequency and storage modulus. If 1/R is negligible compared with 1/δ_{μG}′, then the shear stress at the cylindrical surface is given by the expression:

$${τ}_{S μ {G}^{′}} = - \frac{{V}_{r} {μ}^{′}}{{δ}_{μ {G}^{′}}} = - {V}_{r} sin \frac{Δ}{2} \sqrt{ρ ω {μ}^{′} sin Δ} . \qquad Equation 25$$

A critical value of R is at Rₒₙₛₑₜ=δ_{μG}′ because this represents a cross-over point for the value of R where the shear stress due to the 1/R term becomes larger than the shear stress due to the 1/δ_{μG}, term. In accordance with the techniques described herein, this may be considered the onset of geometric damping.

The dependence of the shear stress on non-linear functions of viscosity, density, frequency and storage modulus is reduced further when R<δ_{μG}′. It may be considered that, if the cylinder radius is less than half of the viscoelastic propagation depth, then geometric damping begins to dominate, i.e. where R<Rₒₙₛₑₜ/2. In other words, R_{geo}=Rₒₙₛₑₜ/2, where R_{geo} may be understood to be a cylinder radius that defines a regime under which geometric damping can be assumed to dominate and define the damping behaviour.

For the measurement of physical properties of a fluid, parameters can be selected to provide improved linearity of fluid loading factors, such as a fluid damping factor, C_{F}, a stiffness loading factor, K_{F}, and an inertial loading factor, J_{F}. If R=δ_{μG}′, then an expression for the fluid viscosity at which the onset of geometric damping occurs is given by:

$${μ}_{onset}^{′} = {R}^{2} ωρ \cdot {sin}^{2} \frac{Δ}{2} \cdot sin Δ = {R}^{2} 2 π f ρ \cdot {sin}^{2} \frac{Δ}{2} \cdot sin Δ , \qquad Equation 26$$

where ω=2πf.

For example, given a cylindrical element having a radius R of 2 mm vibrating in a purely viscous fluid (sin(Δ/2){square root over ((2 sin Δ)=1))} at a frequency of 5 kHz, the fluid having a density p of 1000 kg/m³, then an appropriate choice of fluid viscosity, in units of Pa's, at which R=Rₒₙₛₑₜ is given by:

μ′ₒₙₛₑₜ=2²·π·5000·1000=62

For geometric damping to begin to dominate (i.e. where R_{geo}=Rₒₙₛₑₜ/2), the required viscosity is four times higher, i.e.:

μ′_{geo}=(2·2)²·π·5000·1000=250.

Similarly, a radius of a vibrating element and/or a frequency of vibration can be selected to exploit geometric damping for a given working range of viscosity and density according to operational requirements.

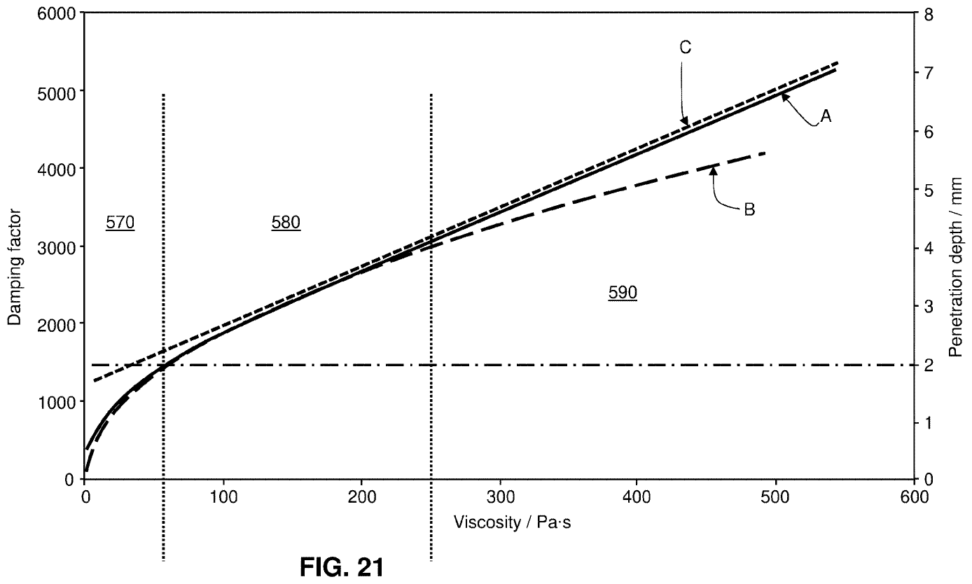

FIG. 21 shows a graph of measured damping factor for a heavy mineral oil using a vibrating cylinder of radius 2 mm at a frequency of 5 kHz, the fluid having a density p of 1000 kg/m³, the damping factor measured over a range of viscosity values (obtained by applying heat to the heavy mineral oil). The measured damping factor is indicated by the solid line denoted by ‘A’ in FIG. 21. The graph also shows a plot of the calculated damping factor if the damping is described by non-geometric damping, i.e. if 1/R is negligible compared with 1/δ_{μG}′. This line is denoted by ‘B’ in FIG. 21. The graph also shows a plot of the calculated damping factor if the damping is described by geometric damping, i.e. if 1/δ_{μG}′, is negligible compared with 1/R. This line is denoted by ‘C’ in FIG. 21.

FIG. 21 demonstrates that, while the viscosity is relatively low, i.e. below approximately 60 Pa's, the radius of the vibrating element is larger than the viscous penetration depth and the shear rate is a non-linear function of viscosity. Where the viscosity is above approximately 60 Pa's, shear wave attenuation begins to be described by geometric damping and the damping factor is seen to become increasingly linear.

FIG. 21 identifies three regions. A first region denoted by reference 570 is a non-linear region and covers viscosity values below μₒₙₛₑₜ (62 Pa's as determined above). A second region denoted by reference 580 is a linear-transition region and covers viscosity values between μₒₙₛₑₜ and μ_{geo} (250 Pa's as determined above). A third region denoted by reference 590 is a fully linear region and covers viscosity values above μ_{geo}. Operating in the second region 580 provides improved linearity compared with operating in the first region 570. Operating in the third region 590 provides improved linearity compared with operating in the second region 580.

Expressions for the fluid damping factor, C_{F}, stiffness loading factor, K_{F}, and inertial loading factor, J_{F}, for a vibrating cylinder of sufficiently wide radius that geometric damping is negligible are given by the following expressions:

$${C}_{F} = ( A \cdot \frac{{R}_{G}^{2}}{{δ}_{μ , {G}^{′}}} ) {μ}^{′} = ( A \cdot {R}_{G}^{2} \frac{1}{sin \frac{Δ}{2}} \sqrt{\frac{2 {μ}^{′}}{ρ ω sin Δ}} ) {μ}^{′} \qquad Equation 27$$

$${K}_{F} = ( A \cdot \frac{{R}_{G}^{2}}{{δ}_{μ , {G}^{′}}} ) {G}^{′} = ( A \cdot {R}_{G}^{2} \frac{1}{sin \frac{Δ}{2}} \sqrt{\frac{2 {μ}^{′}}{ρ ω sin Δ}} ) {G}^{′} \qquad Equation 28$$

$${J}_{F} = ( A \cdot {R}_{G}^{2} \cdot {δ}_{μ , {G}^{′}} ) ρ = ( A \cdot {R}_{G}^{2} \frac{1}{sin \frac{Δ}{2}} \sqrt{\frac{2 {μ}^{′}}{ρ ω sin Δ}} ) ρ \qquad Equation 29$$

In these expressions, each of the factors has a non-linear dependency on μ′, G′, or ρ due to the presence of these terms (or quantities that are a function of these terms, such as A and its dependency on G′) inside the parentheses.

If a vibrating cylinder has a sufficiently small radius that non-geometric damping is negligible, then expressions for C_{F}, K_{F}, and J_{F} are given by:

$${C}_{F} = ( A \cdot \frac{{R}_{G}^{2}}{R} ) {μ}^{′} \qquad Equation 30$$

$${K}_{F} = ( A \cdot \frac{{R}_{G}^{2}}{R} ) {G}^{′} \qquad Equation 31$$

$${J}_{F} = ( A \cdot {R}_{G}^{2} \cdot R ) ρ \qquad Equation 32$$

It can be seen from these expressions where non-geometric damping is negligible that the fluid damping factor, C_{F}, stiffness loading factor, K_{F}, and inertial loading factor, J_{F}, no longer have any non-linear dependency on μ′, G′, or ρ. The quantities C_{F}, K_{F}, and J_{F} each respectively directly proportional to μ′, G′, and ρ, with a constant of proportionality that depends only on geometric parameters.

Improved linearity of these fluid loading factors may be advantageous. A mechanical system may have damping C, stiffness K, and inertia J. These determine the vibration frequency ω and the Q-factor of the system through the following equations:

ω=\sqrt{K/J} Equation 33

$$Q = \frac{\sqrt{K \cdot J}}{C} \qquad Equation 34$$

When the system is vibrating in air or a vacuum, these mechanical factors can be declared C₀, K₀, and J₀. When the system is vibrating a fluid, the physical properties of the fluid ‘load’ these factors by amounts C_{F}, k_{F} and J_{F} respectively.

The overall values for damping, stiffness, and inertia factors of the system taking into account the fluid loading may be expressed as:

C=C₀+c_{F} Equation 35

K=K₀+k_{F} Equation 36

J=J₀+J_{F} Equation 37

The overall values for C, K, and J are related to the above equations for frequency and Q-factor, which are readily measurable. The physical properties of the fluid may be determined based on the contributions of C_{F}, k_{F} and J_{F} to the vibrational behaviour. As discussed below, the techniques of this disclosure may provide simple linear relationships between C_{F}, k_{F} and J_{F} and physical properties of interest, such as density p, viscosity μ′, and storage modulus G′.

In these expressions, A is the fluid-contacting surface area of the cylindrical element and RG is a ‘radius of gyration’ of the element, equal to the radius R of the cylindrical element when the cylindrical element vibrates torsionally about its axis.

In considering the effect of a moment of inertia on rotational motion of a body, the radius of gyration is as the radial distance to a point which would have a moment of inertia the same as the body's actual distribution of mass, if the total mass of the body were concentrated there. The term ‘radius of gyration’ in the present disclosure is a generalisation of this concept to consider torsional factors torsional other than moments of inertia.

In the case of the damping factor, C_{F}, the radius of gyration represents the radial distance to a point which would have the same damping effect as the body's actual damping effect if the damping were concentrated at that point.

In the case of the stiffness loading factor, K_{F}, the radius of gyration represents the radial distance to a point which would have the same stiffness loading effect as the body's actual stiffness loading effect if the stiffness loading were concentrated at that point.

In the case of the inertial loading factor, K_{F}, the radius of gyration represents the radial distance to a point which would have the same inertial loading effect as the body's actual inertial loading effect if the inertial loading were concentrated at that point.

Thus the radius of gyration defined more generally in this disclosure represents a convenient measure of the radial effect of these loading factors. The radius of gyration will be defined by the specific geometry of the cylindrical element, but will generally be assumed to have upper and lower bounds defined by a maximum and minimum radial extent of the cylindrical element from the axis of rotation, and be equal to the radius R of the cylindrical element when the cylindrical element vibrates torsionally about its axis, since all of the surface loading takes place at the cylindrical surface, all at distance R from the axis.

FIG. 20 shows a first cylinder 520 of radius R rotating torsionally about an axis 25 lengthwise through centre of the cylinder. The cylinder has a length l rotating about its axis, where the length is sufficiently long that the area (πR²) of an end portion is small compared to an area of the curved sides (2πRl) and where R<<δ_{μG},, and R=R_{G}, the damping factor, C_{F}, stiffness loading factor, K_{F}, and inertial loading factor, J_{F}, may be written as:

C_{F}=ARμ′=(2πR²l)μ′ Equation 38

K_{F}=ARG′=(2πR²l)G′ Equation 39

J_{F}=A R³ρ=(2πR⁴l)ρ. Equation 40

While geometric damping through the propagation of radial waves brings advantages through a dependency on geometric parameters rather than fluid properties, the conditions for geometric damping encourage the use of a cylindrical element with a small radius, which results in a small active surface area. The small R² term in the damping, stiffness and inertial loading factors means that the damping, or elastic or inertial loading factors from torsional vibration are small, even at high viscosities.

FIG. 20 also shows a second cylinder 530 having the same size as the first cylinder 520, wherein the second cylinder 530 is displaced perpendicularly from the axis of the axis 525 of the first cylinder 520 by an offset radius R_{O} that is greater than R. The second cylinder 530 is also vibrated torsionally about the axis 525 of the first cylinder 520. This has the effect of changing the radius of gyration RG from R (the distance from the cylindrical surface to the axis 525) to R_{O} (the radial offset of the cylinder as a whole).

If the equations provided above for the damping factor, C_{F}, stiffness loading factor, K_{F}, and inertial loading factor, J_{F}, under geometric damping hold (i.e. negligible non-geometric damping), then the equations may be expressed as:

$${C}_{F} = ( A \cdot \frac{{R}_{O}^{2}}{R} ) {μ}^{′} = ( \frac{2 π R l {R}_{O}^{2}}{R} ) {μ}^{′} = ( 2 π l {R}_{O}^{2} ) {μ}^{′} \qquad Equation 41$$

$${K}_{F} = ( A \cdot \frac{{R}_{O}^{2}}{R} ) {G}^{′} = ( \frac{2 π R l {R}_{O}^{2}}{R} ) {G}^{′} = ( 2 π l {R}_{O}^{2} ) {G}^{′} \qquad Equation 42$$

J_{F}=(A·R_{O}²·R)β=(2πRlR_{O}²R)ρ=(2πl R_{O}⁴)ρ. Equation 43

If R_{O} is greater than R then, by offsetting the vibration of the cylindrical element from the axis, the loading factors are amplified the square of the ratio between R_{O} and R, i.e. an amplification of (R_{O}/R)². The loading factors are amplified by (R_{O}/R)⁴ in the case of J_{F}, i.e. the fourth power of the ratio between R_{O} and R.

However, these equations only hold under geometric damping of the cylindrical element. By offsetting the cylindrical element, it no longer undergoes pure torsional oscillation but instead vibrates laterally at the displaced distance. These loading factor equations do not automatically apply because, under lateral vibration, the cylindrical element may form a dipole wave field rather than a monopole wave field.

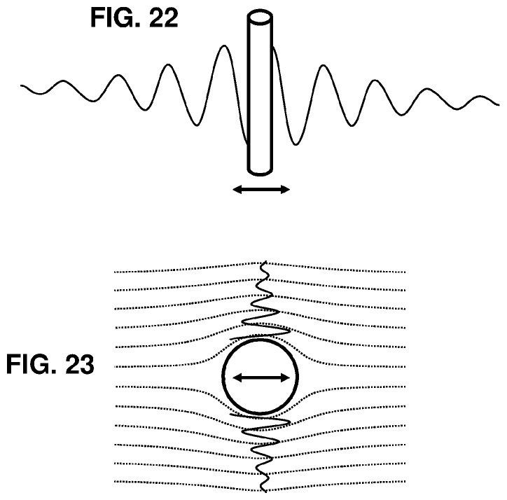

FIG. 22 illustrates a cylindrical element under lateral vibration causing a dipole wave field. Under a dipole wave field, there is a 180° phase difference between the wave field on each side of the cylindrical element. The formation of a dipole wave field is problematic because the resulting waves are pressure (P) waves rather than shear(S) waves. The fluid mechanics of pressure waves are different from shear waves and the previously defined relationships for shear waves no longer apply.

For example, a damping factor is defined differently for a shear wave than for a pressure wave. For a shear wave, the shear rate and the stresses created by the shear rate lead to a relatively well-defined and controllable damping wave. By contrast, pressure waves follow what is known as ‘quadratic damping’, where the damping force is proportional to the square of the velocity. This leads to a damping factor of the form:

C_{quadratic}=b·ν Equation 44

where b is a constant and ν is the velocity. In other words, the damping factor unhelpfully varies with the vibrational velocity.

However, a monopole wave field may be maintained if the Reynolds number is kept low. The Reynolds number signifies a ratio between inertial forces and viscous forces. As the Reynolds number reduces, viscous forces become larger relative to inertial forces.

FIG. 23 illustrates laminar flow around a cylinder vibrating in a left-right direction perpendicular to the cylinder's axis. With laminar flow, the forces across either side of the cylinder become shear and so shear waves propagate as a result of lateral vibration. Without wishing to be bound by theory, it is believed that laminar flow leads to inertial forces being sufficiently low relative to viscous forces that the wave field is largely or at least partially defined by shear waves generated from the upper and lower portions of the cylinder cross-section, i.e. perpendicular to the axis and the direction of vibration. As a result, as the Reynolds number is reduced, the degree to which the wave field has a dipole form is reduced and the degree to which the wave field has a monopole form is increased. The low Reynolds number has restored a partial shear wave field which is in phase throughout its propagation space. The benefits of geometric damping are retained but with the advantage of increased loading factor gain from offsetting the element from the axis.

Advantageously, the cylindrical element displaced from the axis may achieve a relatively high degree of amplification with little increase in size and weight because a relatively low Reynolds number is readily achievable with small length scales. In some implementations of the techniques of this disclosure, fluid loading factor may be achieved that are equivalent to those of much larger and heavier vibratory elements.

It is further recognised that a relatively low Reynolds number is readily achievable for micro- and nanoscale devices for almost all fluids of interest, regardless of their physical properties.

Sub-micron needle structures on a vibrating substrate may form the same radially displaced elements discussed above and achieve the same benefits of geometric damping. Some implementations may feature multiple cylindrical elements or cylinder-like elements, such as pins and spikes, formed by micro- or nano-manufacturing processes, may allow miniature surfaces to present high fluid load factors.

It is further recognised that a low Reynolds number may lead to a wave field is that is only partially defined by shear waves and so expressions for the loading factor under geometric damping conditions might not be identical to the expressions set out above, but may be proportional to those expressions, the constant of proportionality depending on the degree to which the wave field is defined by shear waves. In the following expressions, a constant of proportionality, h, is introduced, wherein h would have a value of 1 if the wave field is wholly defined by shear waves, and would have a value of 0.5 if the wave field is 50% defined by shear waves, which may be a reasonable assumption in practice:

C_{F}=h(2πl R_{O}²)ρ′ Equation 45

K_{F}=h(2πlR_{O}²)G′ Equation 46

J_{F}=h(2πl R_{O}⁴)ρ. Equation 47

If h is assumed to be 0.5, then the above expressions simplify to:

C_{F}=(πR_{O}²)ρ′ Equation 48

K_{F}=(πR_{O}²)G′ Equation 49

J_{F}=(πlR_{O}⁴)ρ. Equation 50

The meaning of a ‘low’ Reynolds number in the context of the present disclosure is that the Reynolds number is sufficiently low that laminar flow is obtained and the flow due to the vibration may be characterised to some degree by a shear wave field and the advantages of geometric damping provided to at least some degree. It is recognised that a laminar-to-turbulent flow transition occurs over a range of Reynolds number values and the precise range over which this transition takes place is dependent on geometry. A lower Reynolds number is more likely to result in flow behaviour leading to a partial shear wave field than a higher Reynolds number. Without wishing to be bound by theory, it is believed that the degree to which a shear wave field develops, and thus some advantages of the techniques of this disclosure are obtained, is dependent on the Reynolds number. For example, a Reynolds number of 1000 may exhibit a degree of laminar-like flow and result in a shear wave field to some degree. A Reynolds number of 100 may exhibit an even greater degree of laminar-like flow and result in a shear wave field to an even greater degree. A Reynolds number of 10 may exhibit an even greater degree of laminar-like flow and result in a shear wave field to an even greater degree. A Reynolds number of 1 may exhibit an even greater degree of laminar-like flow and result in a shear wave field to an even greater degree. In general, a lower Reynolds number may be preferred but the reader will recognise that achieving a lowest possible Reynolds number has to be balanced with other technical considerations.

Provided geometric damping conditions are satisfied, the wave propagation depth is determined by the geometry of the cylindrical element, and specifically its radius.

In view of the above discussion of geometric damping, a radiator or detector surface may be a surface of or comprise an elongate member. Such elongate members may be characterised by a width, a half width that is equal to half of the width, and a length that is greater than the width, wherein the half width is less than a propagation depth of a shear wave in the fluid at the vibration frequency, more preferably less than 50% of the propagation depth. Such elongate members may be non-colinear or offset from an axis of vibration such as an axis of torsional vibration. During vibration, the flow of fluid around the elongate member may be laminar flow.

In some embodiments, the half width of the elongate member is less than 75% of the propagation depth, optionally less than 60%, optionally less than 50%, optionally less than 40%, optionally less than 25%, optionally less than 10%, optionally less than 5%, optionally less than 2%, optionally less than 1%, or optionally less than 0.5%.

In some embodiments, the elongate member has a substantially or wholly circular cross section along 50%, 70%, 90% or 100% of its length. Optionally, along 50%, 70%, 90% or 100% of its length, the elongate member has a cross section that has a circularity in the range 0.75 to 1, optionally in the range 0.8 to 1, optionally in the range 0.85 to 1, optionally in the range 0.9 to 1, optionally in the range 0.95 to 1, more preferably in the range 0.9 to 1, optionally in the range 0.95 to 1, wherein the circularity of a cross section shape is calculated by 4πA/p², where A is the convex area of the cross section shape and p is the convex perimeter of the cross section shape.

In some embodiments, a half width of the elongate member calculated at a point along its length is based on the convex perimeter or the convex area of the cross section of the elongate member at that point along its length. Optionally, the half width is calculated based on the convex perimeter of the shape of the cross section by the expression p/2π. Alternatively, the half width may be calculated based on the convex area of the shape of the cross section by the expression \sqrt{(A/π)}. If the elongate member has a circular cross section then both of these expressions produce the radius of the circle and so the half width of a circular cross section is the radius of the circle.

In some embodiments, the elongate member has a constant cross section along more than 50%, more than 60%, more than 70%, more than 80%, more than 90% or 100% of its length.

In some embodiments, the elongate member only has a constant cross section along less than 50%, less than 40%, less than 30%, less than 20%, less than 10% of its length, or the cross section varies continuously along its length.

In some embodiments, the area of the cross section increases or decreases monotonically along the length of the elongate member.

In some embodiments, the elongate member is straight.

In some embodiments, the elongate member is axially symmetric along its length.

In some embodiments, the elongate member is non-straight. For example, the elongate member may comprise a closed loop.

In some embodiments, the elongate member comprises one of: a circular cylinder, a cone, a frustrum of a cone, a torus, and an arcuate portion of a torus.

In some embodiments, the half width the elongate member that is less than the propagation depth is a maximum half width along the length of the elongate member.

In some embodiments, the half width of the elongate member that is less than the propagation depth is an average half width along the length of the elongate member. Optionally, the average half width is calculated as an arithmetic mean of the half width along the length of the elongate member or is an average half width that is calculated as twice a volume of the elongate member divided by the surface area of the elongate member.

In some embodiments, the width of the elongate member is greater than 0.5 mm, and/or greater than 1 mm, and/or greater than 2 mm, and/or greater than 5 mm, and/or greater than 10 mm, and/or greater than 20 mm, and/or greater than 50 mm.

In some embodiments, the length of the elongate member is greater than a multiple of the half width of the elongate member (the half width being half of the width of the elongate member), and wherein the multiple is one of: 2, 3, 4, 5, 6, 7, 8, 9, 10, 11, 12, 13, 14, 15, 16, 17, 18, 19, 20, 25, 30, 35, 40, 45, or 50. Expressed another way, the length of the elongate member may be greater than a multiple of the width of the elongate member, wherein the multiple is one of 1, 1.5, 2, 2.5, 3, 3.5, 4, 4.5, 5, 5.5, 6, 6.5, 7, 7.5, 8, 8.5, 9, 9.5, 10, 12.5, 15, 17.5, 20, 22.5, and 25.

In some embodiments, the width of the elongate member is between 1 nm and 500 nm. Such embodiments may be described as ‘nanoscale’ or nanoscopic-scale embodiments. In some other embodiments, the width of the elongate member is between 500 nm and 500 μm. Such embodiments may be described as ‘microscale’ or microscopic-scale embodiments. An appropriately dimensioned device, which may be a nanoscale or microscale device, may vibrate at a low frequency to advantageously measure fluid properties of fluids with low viscosities, such as less than 1 mPa·s, or may vibrate at a high frequency to advantageously measure fluid properties of fluids with low viscosities, such as less than 1 mPa·s because, at such small scales, the width of the elongate member may still be small relative to the propagation depth at such high frequencies.

In some embodiments, a vibratory transducer element comprises a shaft that has a longitudinal axis, wherein the elongate member is connected to the shaft and wherein the elongate member is not collinear with the longitudinal axis of the shaft. Optionally, during vibration of the vibratory transducer element at the vibration frequency, the flow of fluid around the elongate member is laminar flow. Alternatively or additionally, a Reynolds number, Re, of fluid flow around the elongate member is less than one, wherein the Reynolds number is equal to 2 Rνρ/μ, where u is a viscosity of the fluid, ρ is a density of the fluid, R is the half width of the elongate member, and ν is a maximum (vibrational) velocity of the elongate member relative to the fluid during vibration of the vibratory transducer, wherein optionally the Reynolds number is less than 1000, or less than 300, or less than 100, or less than 30, or less than 10, or less than 3, or less than 1, or less than 0.9, or less than 0.8, or less than 0.75, or less than 0.7, or less than 0.6, or less than 0.5, or less than 0.4, or less than 0.3, or less than 0.25, or less than 0.2, or less than 0.1. Alternatively or additionally, the elongate member may have a first end and a second end, wherein one or both of the first and second end is spaced from the longitudinal axis of the shaft by an offset distance that is greater than the half width of the elongate member, wherein, optionally, the offset distance is greater than a multiple of the width and the multiple is 2, 3, 4, 5, 6, 7, 8, 9, 10, 11, 12, 13, 14, 15, 20, 30 or 50. Alternatively or additionally, the vibratory transducer element may comprise a plurality of elongate members connected to the shaft that are each not collinear with the axis of the shaft, each having a half width that is less than the propagation depth of a shear wave in the fluid at the vibration frequency, and wherein, optionally, the half width of a first elongate member of the plurality of elongate members is different from the half width of a second elongate member of the plurality of elongate members, and wherein, optionally, two, three, four, five or more of the elongate members of the plurality of elongate members may have uniquely different half widths. Alternatively or additionally, the elongate member may comprise a first end and a second end, wherein the elongate member is connected to the shaft at the first end and optionally also at the second end. Alternatively or additionally, the shaft may comprise a bob and the elongate member may be connected to the shaft at the bob.

Despite the forgoing, the techniques of this disclosure do not require the use of narrow elongate members that exhibit geometric damping as described herein and in GB2207881.0, filed 27 May 2023. For example, the secondary oscillator (secondary system) may instead comprise any system configured to vibrate and resonate within a fluid including all such vibrating devices as known in the art, including but not limited to: a torsion disc, a torsion bob, a tuning fork, a cantilever beam.

Vibratory transducers in accordance with the techniques described herein may be used to determine a physical property of a fluid by vibrating the vibrating transducer in a fluid at a vibration frequency and determining a quantity indicative of a degree of damping based on the vibration. For example, to make a measurement of the viscosity, the Q factor of the vibration can be determined. The Q factor is a dimensionless parameter that indicates the level of damping of a resonator, wherein the level of damping is a function of the viscosity. In particular, it indicates the degree to which a resonator is underdamped. On a plot of frequency response, a high Q factor provides a high and narrow peak at the resonant frequency whereas a low Q factor provides a low and wide peak. Due to the change in width of the peak with damping, the Q factor can be defined as the ratio of the resonant frequency to the resonant bandwidth:

$$Q = \frac{{ω}_{R}}{Δ ω} \qquad Equation 51$$

wherein ω_{R} is the resonant frequency in radians per second and Δ_{ω} is the Full Width at Half Maximum (FWHM), the bandwidth over which the power of the vibration is greater than half of the maximum (or equivalently the amplitude of vibration is greater than the maximum amplitude at resonance divided by \sqrt{2}), i.e. the bandwidth between the 3 dB points. The fluid viscosity is a function of the Q factor.

It should be noted that the measurement of viscosity at or corresponding to a frequency of vibration may comprise making amplitude measurements at more than one frequency to estimate the Q factor but a single viscosity measurement is obtained at a frequency corresponding to the or a resonant frequency. For example, the bandwidth can be determined based on the frequencies required to cause the amplitude to drop to a factor of 1/\sqrt{2} of the maximum amplitude at resonance. As a non-limiting example, the frequencies required to cause the amplitude to drop to a factor of 1/\sqrt{2} of the maximum amplitude at resonance may be determined by performing a frequency sweep around the resonant frequency, but the skilled reader will recognize that the 3 dB point frequencies can be identified by various other techniques.

Another approach to determining the Q factor is to measure the amplitude of vibration at a series of frequencies around the resonant frequency and fit a parabola by the method of least squares to the frequency and amplitude values (or logarithms thereof). The 3 dB points can then be obtained as solutions to a quadratic equation based on the parabola of best fit to the measurements.

Another approach to determining the Q factor is by logarithmic decrement. By ceasing to drive the transducer and measuring the decay of vibrations, the Q factor may be determined by monitoring time series of the vibrations and determining the natural logarithm of the ratio of two successive peaks, A₁ and A₂, by the following expression:

$$Q = \frac{1}{2} \sqrt{1 + {( \frac{2 π}{ln ( \frac{{A}_{1}}{{A}_{2}} )} )}^{2}} . \qquad Equation 52$$

As discussed above, the loss factor is the inverse of the Q factor and so can be readily determined based on the above-described approaches.

In accordance with the techniques of this disclosure, a means for vibrating one or more vibratory transducers may comprise an electronic device configured to provide a control signal to one or more vibratory transducers to cause the one or more vibratory transducers to vibrate in a fluid in a manner in accordance with the techniques of this disclosure.

In accordance with the techniques of this disclosure, a means for determining a material property of the viscoelastic fluid based on the vibrating of the one or more vibratory transducers in the viscoelastic fluid may comprise an electronic device configured to record measurements of the vibrating of the one or more vibratory transducers and process the measurements to determine a material property.

The means for vibrating the one or more vibratory transducers and the means for determining the material property of the viscoelastic fluid based on the one or more vibratory transducers may be the same electronic device (i.e. a single electronic device causes the vibration and determines the material property) or may be different electronic devices.

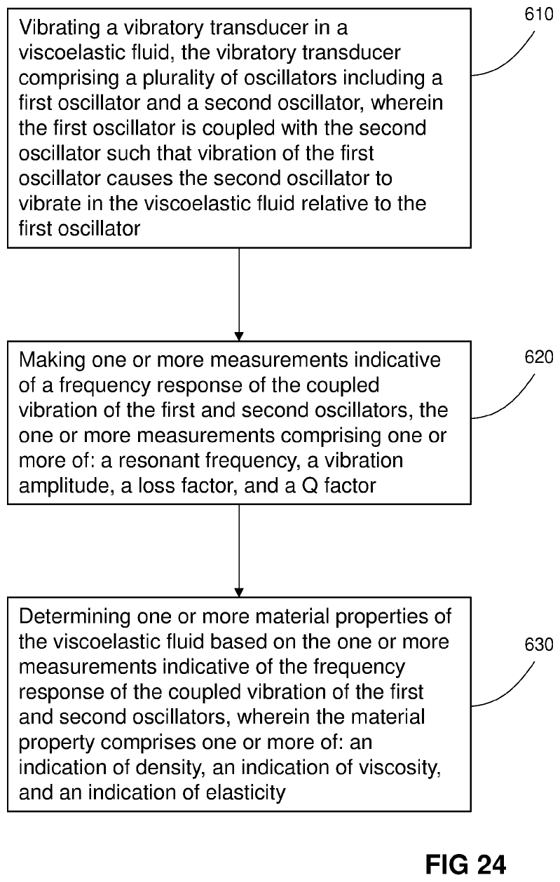

FIG. 24 illustrates a flow chart corresponding to a method of determining one or more material properties of a viscoelastic fluid according to the techniques of this disclosure.

In a first step 610, the method comprises vibrating a vibratory transducer in a viscoelastic fluid, the vibratory transducer comprising a plurality of oscillators including a first oscillator and a second oscillator, wherein the first oscillator is coupled with the second oscillator such that vibration of the first oscillator causes the second oscillator to vibrate in the viscoelastic fluid relative to the first oscillator.

In a second step 620, the method comprises making one or more measurements indicative of a frequency response of the coupled vibration of the first and second oscillators, the one or more measurements comprising one or more of: a resonant frequency, a vibration amplitude, a loss factor, and a Q factor.

In a third step 630, the method comprises determining one or more material properties of the viscoelastic fluid based on the one or more measurements indicative of the frequency response of the coupled vibration of the first and second oscillators, wherein the material property comprises one or more of: an indication of density, an indication of viscosity, and an indication of elasticity.

Such a method may be performed using an apparatus according to the techniques of this disclosure. One such apparatus comprises one or more vibratory transducers, the one or more vibratory transducers each comprising a plurality of oscillators including a first oscillator and a second oscillator for contacting a viscoelastic fluid, wherein the first oscillator is coupled with the second oscillator such that vibration of the first oscillator causes the second oscillator to vibrate in the viscoelastic fluid relative to the first oscillator; and a controller configured to: vibrate the one or more vibratory transducers in a viscoelastic fluid; make one or more measurements indicative of a frequency response of the coupled vibration of the first and second oscillators, the one or more measurements comprising one or more of: a resonant frequency, a vibration amplitude, a loss factor, and a Q factor; determine one or more material properties of the viscoelastic fluid based on the one or more measurements indicative of the frequency response of the coupled vibration of the first and second oscillators, wherein the material property comprises one or more of: an indication of density, an indication of viscosity, and an indication of elasticity. The controller may be implemented as an electronic device such as a general-purpose computer or using dedicated circuitry such as application-specific integrated circuits or field-programmable gate arrays, or using some combination of the above.

In the context of this disclosure, where a frequency is within a percentage of another, the frequency may be above or below the other frequency and within the percentage range of the other frequency; for example, for frequencies ω1 and ω2, if ω1 is within 20% of ω2, then 0.8·ω₂≤ω₁≤1.2·ω₂.

The skilled reader will further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

1. A method of determining one or more material properties of a viscoelastic fluid, the method comprising:
vibrating one or more vibratory transducers in a viscoelastic fluid, the one or more vibratory transducers each comprising a plurality of oscillators including a first oscillator and a second oscillator, wherein the first oscillator is coupled with the second oscillator such that vibration of the first oscillator causes the second oscillator to vibrate in the viscoelastic fluid relative to the first oscillator;
making one or more measurements indicative of a frequency response of the coupled vibration of the first and second oscillators, the one or more measurements comprising one or more of: a resonant frequency, a vibration amplitude, a loss factor, and a Q factor;
determining one or more material properties of the viscoelastic fluid based on the one or more measurements indicative of the frequency response of the coupled vibration of the first and second oscillators, wherein the material property comprises one or more of: an indication of density, an indication of viscosity, and an indication of elasticity.

2. The method of claim 2, wherein vibrating the one or more vibratory transducers comprises vibrating the first oscillator of a vibratory transducer at a frequency that is within 20% of a natural frequency of the second oscillator of that vibratory transducer and optionally within 10%.

3. The method of claim 1 or claim 2, wherein vibrating the one or more vibratory transducers comprises vibrating a first oscillator of a vibratory transducer at a frequency that is more than 150% of the natural frequency of the second oscillator of that vibratory transducer and optionally more than 200%.

4. The method of any preceding claim,
wherein vibrating the one or more vibratory transducers comprises vibrating the first oscillator of a vibratory transducer at a first frequency that is within 20% of a natural frequency of the second oscillator of that vibratory transducer and optionally within 10%, or is less than 50% of a natural frequency of the second oscillator of that vibratory transducer,
wherein vibrating the one or more vibratory transducers further comprises vibrating a first oscillator of a vibratory transducer at a second frequency that is more than 150% of the natural frequency of the second oscillator of that vibratory transducer and optionally more than 200%,
wherein determining the one or more material properties comprises combining results obtained from measurements at the first frequency with results obtained from measurements at the second frequency to reduce common-mode error.

5. The method of claim 4, wherein combining results obtained from measurements at the first driving frequency with results obtained from measurements at the second driving frequency comprises obtaining a difference or a weighted difference or ratio of the results to reduce common-mode error.

6. The method of claim 5, wherein combining results obtained from measurements at the first driving frequency with results obtained from measurements at the second driving frequency comprises obtaining a difference or a weighted difference or ratio of measurements of a resonant frequency.

7. The method of any of claims 4 to 6, comprising vibrating a same vibratory transducer at both the first and second frequencies.

8. The method of any of claims 4 to 6, comprising vibrating a first vibratory transducer at the first frequency and a second vibratory transducer at the second frequency.

9. The method of any preceding claim,
wherein the one or more vibratory transducers are vibrated at a plurality of frequencies in the viscoelastic material and a respective plurality of measurements of loss factor are obtained,
wherein the method further comprises determining a composition of the viscoelastic material based on the plurality of measurements of loss factor.

10. The method of claim 9, wherein determining a composition of the viscoelastic material comprises determining one or more values indicative of a loss factor curve for the viscoelastic material based on the plurality of measurements of loss factor and comparing the one or more values to a plurality of stored values for a plurality of different materials.

11. The method of any preceding claim, wherein the first and second oscillators of a vibratory transducer are each vibrated in one of: a torsional mode, a lateral mode or a longitudinal mode, wherein the first oscillator is vibrated in a different mode to the second oscillator.

12. The method of claim 11, wherein the first oscillator is vibrated in a torsional mode and the second oscillator is vibrated in a lateral mode.

13. The method of any preceding claim, wherein the second oscillator of a vibratory transducer comprises an elongate member.

14. The method of claim 13, wherein the elongate member is characterized by a width and a length, wherein the width is between 0.1 mm and 5 mm, and wherein the length is at least five times the width.

15. The method of claim 13, wherein the elongate member is characterised by a width, a half width that is equal to half of the width, and a length that is greater than the width, wherein the half width is less than a propagation depth of a shear wave in the fluid at a vibration frequency of the second oscillator, wherein the propagation depth of a shear wave is a distance over which an amplitude of a shear wave propagating in the fluid at the vibration frequency of the second oscillator is reduced by a factor of 1/e.

16. The method of any of claims 13 to 15, wherein vibrating the vibratory transducer comprises vibrating the primary oscillator in a torsional mode about a longitudinal axis, wherein the elongate member of the second oscillator has a first end and a second end, wherein one or both of the first and second ends is spaced from the longitudinal axis by an offset distance that is greater than the half width of the elongate member.

17. The method of any of claims 13 to 16, wherein the elongate member extends in a direction that is either substantially parallel to or substantially perpendicular to the longitudinal axis of the first oscillator.

18. The method of any preceding claim, wherein vibrating the one or more vibratory transducers in a viscoelastic fluid comprises vibrating the one or more vibratory transducers in a flowing viscoelastic fluid.

19. An apparatus for determining one or more material properties of a viscoelastic fluid, the apparatus comprising:
one or more vibratory transducers, the one or more vibratory transducers each comprising a plurality of oscillators including a first oscillator and a second oscillator for contacting a viscoelastic fluid, wherein the first oscillator is coupled with the second oscillator such that vibration of the first oscillator causes the second oscillator to vibrate in the viscoelastic fluid relative to the first oscillator; and
a controller configured to:
vibrate the one or more vibratory transducers in a viscoelastic fluid;
make one or more measurements indicative of a frequency response of the coupled vibration of the first and second oscillators, the one or more measurements comprising one or more of: a resonant frequency, a vibration amplitude, a loss factor, and a Q factor;
determine one or more material properties of the viscoelastic fluid based on the one or more measurements indicative of the frequency response of the coupled vibration of the first and second oscillators, wherein the material property comprises one or more of: an indication of density, an indication of viscosity, and an indication of elasticity.

20. The apparatus of claim 19, wherein vibrating the one or more vibratory transducers comprises vibrating the first oscillator of a vibratory transducer at a frequency that is within 20% of a natural frequency of the second oscillator of that vibratory transducer and optionally within 10%.

21. The apparatus of claim 19 or claim 20, wherein vibrating the one or more vibratory transducers comprises vibrating a first oscillator of a vibratory transducer at a frequency that is more than 150% of the natural frequency of the second oscillator of that vibratory transducer and optionally more than 200%.

22. The apparatus of any of claims 19 to 21,
wherein vibrating the one or more vibratory transducers comprises vibrating the first oscillator of a vibratory transducer at a first frequency that is within 20% of a natural frequency of the second oscillator of that vibratory transducer and optionally within 10%, or is less than 50% of a natural frequency of the second oscillator of that vibratory transducer,
wherein vibrating the one or more vibratory transducers further comprises vibrating a first oscillator of a vibratory transducer at a second frequency that is more than 150% of the natural frequency of the second oscillator of that vibratory transducer and optionally more than 200%,
wherein determining the one or more material properties comprises combining results obtained from measurements at the first frequency with results obtained from measurements at the second frequency to reduce common-mode error, wherein combining results obtained from measurements at the first driving frequency with results obtained from measurements at the second driving frequency comprises obtaining a difference or a weighted difference or ratio of the results to reduce common-mode error.

23. The apparatus of claim 22, wherein the controller is configured to vibrate a same vibratory transducer at both the first and second frequencies.

24. The apparatus of claim 22, comprising a plurality of vibratory transducers including a first vibratory transducer and a second vibratory transducer, wherein the controller is configured to vibrate the first vibratory transducer at the first frequency and the second vibratory transducer at the second frequency.

25. The apparatus of any of claims 19 to 24,
wherein the controller is configured to vibrate the one or more vibratory transducers at a plurality of frequencies in the viscoelastic material and obtain a respective plurality of measurements of loss factor,
wherein the controller is further configured to determine a composition of the viscoelastic material based on the plurality of measurements of loss factor.

26. The apparatus of claim 25, wherein determining a composition of the viscoelastic material comprises determining one or more values indicative of a loss factor curve for the viscoelastic material based on the plurality of measurements of loss factor and comparing the one or more values to a plurality of stored values for a plurality of different materials.

27. The apparatus any of claims 19 to 26, wherein the first and second oscillators of a vibratory transducer are each configured to vibrate in one of: a torsional mode, a lateral mode or a longitudinal mode, wherein the first oscillator is configured to vibrate in a different mode to the second oscillator.

28. The apparatus of any of claims 19 to 27, wherein the second oscillator of a vibratory transducer comprises an elongate member.

29. The apparatus of claim 28, wherein the elongate member is characterized by a width and a length, wherein the width is between 0.1 mm and 5 mm, and wherein the length is at least five times the width.

30. The apparatus of claim 28, wherein the elongate member is characterised by a width, a half width that is equal to half of the width, and a length that is greater than the width, wherein the half width is less than a propagation depth of a shear wave in the fluid at a vibration frequency of the second oscillator, wherein the propagation depth of a shear wave is a distance over which an amplitude of a shear wave propagating in the fluid at the vibration frequency of the second oscillator is reduced by a factor of 1/e.

31. The apparatus of any of claims claims 28 to 30, wherein the vibratory transducer is configured to vibrate the primary oscillator in a torsional mode about a longitudinal axis, wherein the elongate member of the second oscillator has a first end and a second end, wherein one or both of the first and second ends is spaced from the longitudinal axis by an offset distance that is greater than the half width of the elongate member.

32. The apparatus of claim 31, wherein the elongate member extends in a direction that is either substantially parallel to or substantially perpendicular to the longitudinal axis of the first oscillator.

33. An apparatus for determining one or more material properties of a viscoelastic fluid, the apparatus comprising:
means for vibrating one or more vibratory transducers in a viscoelastic fluid, the one or more vibratory transducers each comprising a plurality of oscillators including a first oscillator and a second oscillator, wherein the first oscillator is coupled with the second oscillator such that vibration of the first oscillator causes the second oscillator to vibrate in the viscoelastic fluid relative to the first oscillator;
means for making one or more measurements indicative of a frequency response of the coupled vibration of the first and second oscillators, the one or more measurements comprising one or more of: a resonant frequency, a vibration amplitude, a loss factor, and a Q factor;
means for determining one or more material properties of the viscoelastic fluid based on the one or more measurements indicative of the frequency response of the coupled vibration of the first and second oscillators, wherein the material property comprises one or more of: an indication of density, an indication of viscosity, and an indication of elasticity.
